(19) United States
(12) Patent Application Publication
(10) Pub. No.: US 2026/0145418 A1
(43) Pub. Date: May 28, 2026

(54) LIQUID DISCHARGE APPARATUS, HEAD UNIT, AND INSPECTION METHOD OF LIQUID DISCHARGE APPARATUS

(71) Applicant: SEIKO EPSON CORPORATION, Tokyo (JP)

(72) Inventors: Kazunari TSUKADA, Matsumoto (JP); Toru MATSUYAMA, Matsumoto (JP); Daichi ORIHARA, Shiojiri (JP)

(21) Appl. No.: 19/399,708

(22) Filed: Nov. 25, 2025

(30) Foreign Application Priority Data
Nov. 27, 2024 (JP) 2024-206256

(51) Int. Cl. B41J 2/045

(52) U.S. Cl. CPC B41J 2/0451; B41J 2/04541; B41J 2/04581; B41J 2/04588

(57) ABSTRACT

A liquid discharge apparatus includes a first discharge section including a first piezoelectric element that is displaced in response to a drive signal, a second discharge section including a second piezoelectric element that is displaced in response to the drive signal, and an inspection section that inspects a state of the first discharge section based on a detection signal corresponding to a potential of the first piezoelectric element in an inspection period, in which the drive signal changes in potential from a first potential to a second potential in a second period, maintains the second potential in a third period, and changes in potential from the second potential to the first potential in a fourth period, the third period includes the inspection period, and the second period is longer than the fourth period.

The present application is based on, and claims priority from JP Application Serial Number 2024-206256, filed Nov. 27, 2024, the disclosure of which is hereby incorporated by reference herein in its entirety.

### BACKGROUND

### 1. Technical Field

The present disclosure relates to a liquid discharge apparatus, a head unit, and an inspection method of the liquid discharge apparatus.

### 2. Related Art

A liquid discharge apparatus such as an ink jet printer drives a piezoelectric element provided in a discharge section with a drive signal to discharge a liquid such as ink filling the discharge section by displacing the piezoelectric element, and executes a printing process of forming an image on a medium. However, in the liquid discharge apparatus, a discharge abnormality in which the liquid cannot be normally discharged from the discharge section may occur. When the discharge abnormality occurs, the image quality of the image formed on the medium in the printing process deteriorates. Therefore, a technique for inspecting a state of the discharge section has been proposed in the related art. For example, JP-A-2018-047638 discloses a technique for inspecting a state of a discharge section based on a potential of a piezoelectric element provided in the discharge section.

However, in the related art, vibration sometimes occurred in the piezoelectric element provided in the discharge section when the piezoelectric element is driven by the drive signal. In this case, the potential of the piezoelectric element provided in the discharge section to be inspected fluctuated, and the state of the discharge section could not be accurately inspected.

### SUMMARY

According to an aspect of the present disclosure, there is provided a liquid discharge apparatus including: a first discharge section including a first piezoelectric element that is displaced in response to a drive signal and configured to discharge a liquid in response to the displacement of the first piezoelectric element; a second discharge section including a second piezoelectric element that is displaced in response to the drive signal and configured to discharge the liquid in response to the displacement of the second piezoelectric element; and an inspection section that inspects a state of the first discharge section based on a detection signal corresponding to a potential of the first piezoelectric element in an inspection period included in a unit period when the drive signal is supplied to the second piezoelectric element in the unit period, in which the drive signal maintains a first potential in a first period in the unit period, changes in potential from the first potential to a second potential in a second period following the first period in the unit period, maintains the second potential in a third period following the second period in the unit period, changes in potential from the second potential to the first potential in a fourth period following the third period in the unit period, and maintains the first potential in a fifth period following the fourth period in the unit period, the third period includes the inspection period, and the second period is longer than the fourth period.

According to another aspect of the present disclosure, there is provided a liquid discharge apparatus including: a first discharge section including a first piezoelectric element that is displaced in response to a drive signal and configured to discharge a liquid in response to the displacement of the first piezoelectric element; and an inspection section that inspects a state of the first discharge section based on a detection signal corresponding to a potential of the first piezoelectric element in an inspection period included in a unit period when the drive signal is supplied to the first piezoelectric element in a drive period included in the unit period, in which the drive signal maintains a first potential in a first period in the unit period, changes in potential from the first potential to a second potential in a second period following the first period in the unit period, maintains the second potential in a third period following the second period in the unit period, changes in potential from the second potential to the first potential in a fourth period following the third period in the unit period, and maintains the first potential in a fifth period following the fourth period in the unit period, the third period includes the inspection period, the drive period does not include the inspection period and includes at least the second period, and the second period is longer than the fourth period.

According to still another aspect of the present disclosure, there is provided a liquid discharge apparatus including: a first discharge section including a first piezoelectric element that is displaced in response to a drive signal and configured to discharge a liquid in response to the displacement of the first piezoelectric element; a second discharge section including a second piezoelectric element that is displaced in response to the drive signal and configured to discharge the liquid in response to the displacement of the second piezoelectric element; and an inspection section that inspects a state of the first discharge section based on a detection signal corresponding to a potential of the first piezoelectric element in an inspection period included in a unit period when the drive signal is supplied to the second piezoelectric element in the unit period, in which the drive signal changes in potential from a first potential to a second potential in a first transition period in the unit period, maintains the second potential in a maintenance period following the first transition period in the unit period, and changes in potential from the second potential to the first potential in a second transition period following the maintenance period in the unit period, the maintenance period includes the inspection period, and the first transition period is longer than the second transition period.

According to still another aspect of the present disclosure, there is provided a head unit including: a first discharge section including a first piezoelectric element that is displaced in response to a drive signal and configured to discharge a liquid in response to the displacement of the first piezoelectric element; a second discharge section including a second piezoelectric element that is displaced in response to the drive signal and configured to discharge the liquid in response to the displacement of the second piezoelectric element; and a detection section that detects a potential of the first piezoelectric element in an inspection period included in a unit period when the drive signal is supplied to the second piezoelectric element in the unit period, in which the drive signal maintains a first potential in a first period in the unit period, changes in potential from the first potential to a second potential in a second period following the first period in the unit period, maintains the second potential in a third period following the second period in the unit period, changes in potential from the second potential to the first potential in a fourth period following the third period in the unit period, and maintains the first potential in a fifth period following the fourth period in the unit period, the third period includes the inspection period, and the second period is longer than the fourth period.

According to still another aspect of the present disclosure, there is provided a head unit including: a first discharge section including a first piezoelectric element that is displaced in response to a drive signal and configured to discharge a liquid in response to the displacement of the first piezoelectric element; and a detection section that detects a potential of the first piezoelectric element in an inspection period included in a unit period when the drive signal is supplied to the first piezoelectric element in a drive period included in the unit period, in which the drive signal maintains a first potential in a first period in the unit period, changes in potential from the first potential to a second potential in a second period following the first period in the unit period, maintains the second potential in a third period following the second period in the unit period, changes in potential from the second potential to the first potential in a fourth period following the third period in the unit period, and maintains the first potential in a fifth period following the fourth period in the unit period, the third period includes the inspection period, the drive period does not include the inspection period and includes at least the second period, and the second period is longer than the fourth period.

According to still another aspect of the present disclosure, there is provided a head unit including: a first discharge section including a first piezoelectric element that is displaced in response to a drive signal and configured to discharge a liquid in response to the displacement of the first piezoelectric element; a second discharge section including a second piezoelectric element that is displaced in response to the drive signal and configured to discharge the liquid in response to the displacement of the second piezoelectric element; and a detection section that detects a potential of the first piezoelectric element in an inspection period included in a unit period when the drive signal is supplied to the second piezoelectric element in the unit period, in which the drive signal changes in potential from a first potential to a second potential in a first transition period in the unit period, maintains the second potential in a maintenance period following the first transition period in the unit period, and changes in potential from the second potential to the first potential in a second transition period following the maintenance period in the unit period, the maintenance period includes the inspection period, and the first transition period is longer than the second transition period.

In addition, according to still another aspect of the present disclosure, there is provided an inspection method of a liquid discharge apparatus including a first discharge section including a first piezoelectric element that is displaced in response to a drive signal and configured to discharge a liquid in response to the displacement of the first piezoelectric element, and a second discharge section including a second piezoelectric element that is displaced in response to the drive signal and configured to discharge the liquid in response to the displacement of the second piezoelectric element, the inspection method including: inspecting a state of the first discharge section based on a detection signal corresponding to a potential of the first piezoelectric element in an inspection period included in a unit period when the drive signal is supplied to the second piezoelectric element in the unit period, in which the drive signal maintains a first potential in a first period in the unit period, changes in potential from the first potential to a second potential in a second period following the first period in the unit period, maintains the second potential in a third period following the second period in the unit period, changes in potential from the second potential to the first potential in a fourth period following the third period in the unit period, and maintains the first potential in a fifth period following the fourth period in the unit period, the third period includes the inspection period, and the second period is longer than the fourth period.

In addition, according to still another aspect of the present disclosure, there is provided an inspection method of a liquid discharge apparatus including a first discharge section including a first piezoelectric element that is displaced in response to a drive signal and configured to discharge a liquid in response to the displacement of the first piezoelectric element, the inspection method including: inspecting a state of the first discharge section based on a detection signal corresponding to a potential of the first piezoelectric element in an inspection period included in a unit period when the drive signal is supplied to the first discharge section in a drive period included in the unit period, in which the drive signal maintains a first potential in a first period in the unit period, changes in potential from the first potential to a second potential in a second period following the first period in the unit period, maintains the second potential in a third period following the second period in the unit period, changes in potential from the second potential to the first potential in a fourth period following the third period in the unit period, and maintains the first potential in a fifth period following the fourth period in the unit period, the third period includes the inspection period, the drive period does not include the inspection period and includes at least the second period, and the second period is longer than the fourth period.

In addition, according to still another aspect of the present disclosure, there is provided an inspection method of a liquid discharge apparatus including a first discharge section including a first piezoelectric element that is displaced in response to a drive signal and configured to discharge a liquid in response to the displacement of the first piezoelectric element, and a second discharge section including a second piezoelectric element that is displaced in response to the drive signal and configured to discharge the liquid in response to the displacement of the second piezoelectric element, the inspection method including: inspecting a state of the first discharge section based on a detection signal corresponding to a potential of the first piezoelectric element in an inspection period included in a unit period when the drive signal is supplied to the second piezoelectric element in the unit period, in which the drive signal changes in potential from a first potential to a second potential in a first transition period in the unit period, maintains the second potential in a maintenance period following the first transition period in the unit period, and changes in potential from the second potential to the first potential in a second transition period following the maintenance period in the unit period, the maintenance period includes the inspection period, and the first transition period is longer than the second transition period.

### BRIEF DESCRIPTION OF THE DRAWINGS

FIG. 1 is a block diagram illustrating an example of a configuration of an ink jet printer according to an embodiment of the present disclosure.

FIG. 2 is a perspective view illustrating an example of a schematic internal structure of the ink jet printer.

FIG. 3 is a sectional view for describing an example of a structure of a discharge section.

FIG. 4 is a plan view illustrating an example of disposition of nozzles in the ink jet printer.

FIG. 5 is a block diagram illustrating an example of a configuration of a head unit.

FIG. 6 is a timing chart for describing an example of a signal supplied to the head unit.

FIG. 7 is an explanatory diagram for describing an example of an operation of a coupling state designation circuit.

FIG. 8 is a timing chart for describing an example of a signal supplied to the head unit.

FIG. 9 is an explanatory diagram for describing an example of an operation of the coupling state designation circuit.

FIG. 10 is an explanatory diagram illustrating an example of an operation of the head unit.

FIG. 11 is an explanatory diagram illustrating an example of the operation of the head unit.

FIG. 12 is an explanatory diagram illustrating an example of the operation of the head unit.

FIG. 13 is an explanatory diagram illustrating an example of a detection potential signal.

FIG. 14 is an explanatory diagram illustrating an example of a detection potential signal.

FIG. 15 is an explanatory diagram illustrating an example of a detection potential signal.

FIG. 16 is an explanatory diagram illustrating an example of a detection potential signal.

FIG. 17 is an explanatory diagram for describing an example of a detection potential signal according to a comparative example.

FIG. 18 is an explanatory diagram illustrating an example of the detection potential signal according to the comparative example.

FIG. 19 is an explanatory diagram for describing an example of an operation of a coupling state designation circuit according to a modification example.

FIG. 20 is a timing chart for describing an example of a signal supplied to a head unit in a modification example.

### DESCRIPTION OF EMBODIMENTS

Hereinafter, embodiments for carrying out the present disclosure will be described with reference to the drawings. Meanwhile, a dimension and a scale of each section are different from actual ones as appropriate in each drawing. The embodiments described below are preferred specific examples of the present disclosure and are thus added with technically preferred various limitations, but the scope of the present disclosure is not limited to such embodiments unless description for limiting the present disclosure is made in the following description.

### A. EMBODIMENT

In the present embodiment, a liquid discharge apparatus will be described by exemplifying an ink jet printer that forms an image on recording paper PP by discharging ink.

### 1. Overview of Ink Jet Printer

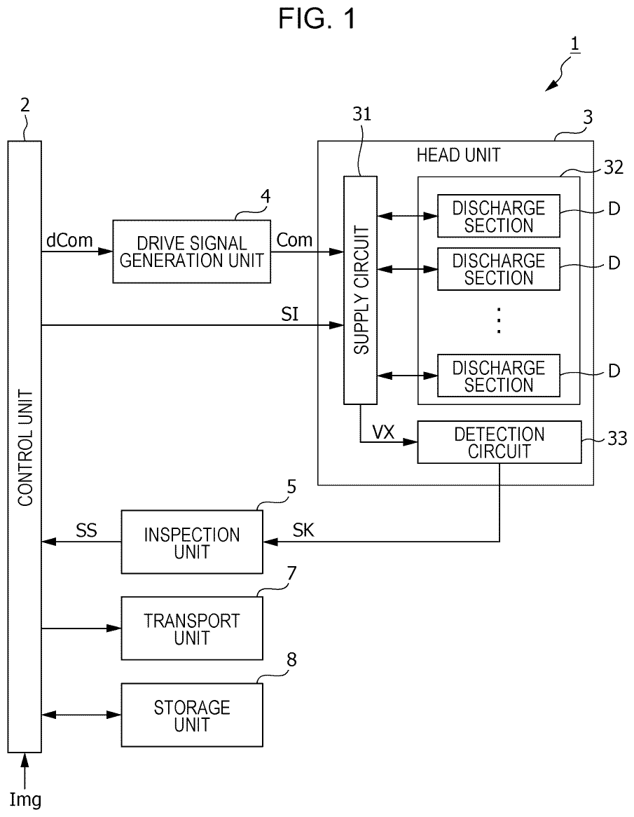

Hereinafter, an example of a configuration of an ink jet printer 1 according to the present embodiment will be described with reference to FIGS. 1 to 4.

FIG. 1 is a functional block diagram illustrating an example of a configuration of an ink jet printer 1.

As illustrated in FIG. 1, the ink jet printer 1 is supplied with print data Img indicating an image to be formed by the ink jet printer 1 from a host computer such as a personal computer or a digital camera. The ink jet printer 1 executes a printing process of forming the image, which is indicated by the print data Img supplied from the host computer, on the recording paper PP.

As illustrated in FIG. 1, the ink jet printer 1 includes a control unit 2 that controls each section of the ink jet printer 1, a head unit 3 provided with a discharge section D that discharges ink, a drive signal generation unit 4 that generates a drive signal Com for driving the discharge section D, an inspection unit 5 that inspects a state of the discharge section D, a transport unit 7 that changes a relative position of a recording paper PP with respect to the head unit 3, and a storage unit 8 that stores various information.

The ink jet printer 1 is an example of a “liquid discharge apparatus”, the ink is an example of a “liquid”, and the inspection unit 5 is an example of an “inspection section”.

In the present embodiment, it is assumed that the ink jet printer 1 includes one or more head units 3, one or more drive signal generation units 4 corresponding to the one or more head units 3 on a one-to-one basis, and one or more inspection units 5 corresponding to the one or more head units 3 on a one-to-one basis. Specifically, in the present embodiment, it is assumed that the ink jet printer 1 includes four head units 3, four drive signal generation units 4 corresponding to the four head units 3 on a one-to-one basis, and four inspection units 5 corresponding to the four head units 3 on a one-to-one basis. Meanwhile, in the following, for convenience of description, as illustrated in FIG. 1, the description will focus on one head unit 3 of the four head units 3, one drive signal generation unit 4 of the four drive signal generation units 4 provided corresponding to the one head unit 3, and one inspection unit 5 of the four inspection units 5 provided corresponding to the one head unit 3.

The storage unit 8 is configured to include one or both of a volatile memory such as a random access memory (RAM) and a non-volatile memory such as a read only memory (ROM), an electrically erasable programmable read-only memory (EEPROM), or a programmable ROM (PROM), and stores a control program of the ink jet printer 1.

The control unit 2 is configured to include one or more central processing units (CPU). However, the control unit 2 may be provided with a programmable logic device such as a field-programmable gate array (FPGA) instead of the CPU or in addition to the CPU. The control unit 2 executes a control program stored in the storage unit 8, and is operated in accordance with the control program to control each section of the ink jet printer 1.

Specifically, the control unit 2 generates a waveform designation signal dCom and supplies the generated waveform designation signal dCom to the drive signal generation unit 4. The waveform designation signal dCom is a digital signal that defines the waveform of the drive signal Com. The drive signal Com is an analog signal for driving the discharge section D. The drive signal generation unit 4 includes a DA converter circuit and generates the drive signal Com having the waveform defined by the waveform designation signal dCom. In the present embodiment, it is assumed that the drive signal Com includes a drive signal Com-A and a drive signal Com-B.

Further, the control unit 2 generates a designation signal SI and supplies the generated designation signal SI to the head unit 3. The designation signal SI is a digital signal designating the type of operation of the discharge section D. Specifically, the designation signal SI is a signal that designates the type of operation of the discharge section D by designating whether the discharge section D is driven by supplying the drive signal Com to the discharge section D.

When the printing process is executed, the control unit 2 generates a signal for controlling the head unit 3, such as the designation signal SI, based on the print data Img. In addition, the control unit 2 generates a signal for controlling the drive signal generation unit 4, such as the waveform designation signal dCom, when the printing process is executed. In addition, the control unit 2 generates a signal for controlling the transport unit 7 when the printing process is executed. As a result, the control unit 2 controls the transport unit 7 to change the relative position of the recording paper PP with respect to the head unit 3 in the printing process, adjusts the presence/absence of ink discharge from the discharge section D, the discharge timing of ink, and the like, and controls each section of the ink jet printer 1 to form an image corresponding to the print data Img on the recording paper PP.

As illustrated in FIG. 1, the head unit 3 includes a supply circuit 31, a recording head 32, and a detection circuit 33.

The recording head 32 includes M discharge sections D. In this case, a value M is a natural number that satisfies “M≥2”. Hereinafter, among the M discharge sections D provided in the recording head 32, the m-th discharge section D may be referred to as a discharge section D[m]. In this case, the variable m is a natural number that satisfies “1≤m≤M”. In addition, in the following, when a component, signal, or the like of the ink jet printer 1 corresponds to the discharge section D[m] among the M discharge sections D, a subscript [m] may be added to a code for representing the component, signal, or the like.

The supply circuit 31 switches whether to supply the drive signal Com to the discharge section D[m] based on the designation signal SI. In the following, among the drive signals Com, the drive signal Com supplied to the discharge section D[m] may be referred to as a supply drive signal Vin[m].

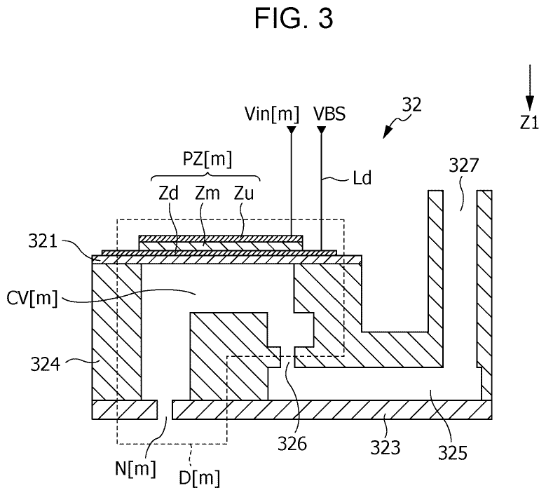

Further, the supply circuit 31 switches whether to supply a detection potential signal VX[m] to the detection circuit 33 based on the designation signal SI. Here, the detection potential signal VX[m] is a signal indicating the potential of an upper electrode Zu[m] provided in the piezoelectric element PZ[m] included in the discharge section D[m]. In the following, when the detection potential signal VX[m] is supplied from the discharge section D[m] to the detection circuit 33, the discharge section D[m] may be referred to as an inspection target discharge section DK. The piezoelectric element PZ[m] and the upper electrode Zu[m] will be described later in FIG. 3.

The detection circuit 33 generates a detection signal SK[m] based on the detection potential signal VX[m] supplied from the discharge section D[m], which is set as the inspection target discharge section DK, via the supply circuit 31. Specifically, the detection circuit 33 generates the detection signal SK[m] by, for example, amplifying the detection potential signal VX[m] and removing a noise component. The detection circuit 33 is an example of a “detection section”.

The inspection unit 5 inspects the state of the discharge section D[m] designated as the inspection target discharge section DK based on the detection signal SK[m] supplied from the detection circuit 33, and outputs an inspection result signal SS[m] indicating the result of the inspection. In the present embodiment, it is assumed that the “inspection of the state of the discharge section D[m]” is an electric storage capacity inspection. The electric storage capacity inspection is an inspection of determining whether the piezoelectric element PZ[m] provided in the discharge section D[m] has a predetermined electric storage capacity.

Here, the “predetermined electric storage capacity” is, for example, the capacity of the piezoelectric element PZ[m] to maintain the potential for a predetermined period when the upper electrode Zu[m] of the piezoelectric element PZ[m] is set to a desired potential by supplying the drive signal Com to the piezoelectric element PZ[m]. That is, “a case where the piezoelectric element PZ[m] does not have a predetermined electric storage capacity” is, for example, a case where an electrical short-circuit path is formed between the piezoelectric element PZ[m] of the discharge section D[m] and the piezoelectric element PZ of another discharge section D, and as a result, a leak current flows through the short-circuit path, and the upper electrode Zu[m] of the piezoelectric element PZ[m] of the discharge section D[m] cannot maintain a desired potential for a predetermined period. Here, the “predetermined period” is, for example, a period in which the upper electrode Zu[m] of the piezoelectric element PZ[m] is to maintain a desired potential in the printing process in order to form an image indicated by the print data Img on the recording paper PP in the printing process. Specifically, the “predetermined period” may be a period corresponding to a drive cycle of the piezoelectric element PZ[m] by the drive signal Com, or may be a period shorter than the drive cycle of the piezoelectric element PZ[m] by the drive signal Com. In addition, the “maintaining the desired potential” includes, for example, a case where the same potential as the desired potential is maintained, and a case where a potential substantially the same as the desired potential is maintained. Here, the “substantially the same potential as the desired potential” may be, for example, a potential that is considered to be the same when an error is taken into consideration.

When the piezoelectric element PZ[m] included in the discharge section D[m] does not have a predetermined electric storage capacity, the potential of the upper electrode Zu[m] included in the piezoelectric element PZ[m] is set to a potential different from the potential defined by the drive signal Com. Therefore, when the piezoelectric element PZ[m] does not have the predetermined electric storage capacity, the discharge section D[m] discharges an amount of ink different from the discharge amount of ink defined by the drive signal Com, and the discharge section D[m] discharges the ink at a speed different from the discharge speed of the ink defined by the drive signal Com. Therefore, when the piezoelectric element PZ[m] does not have the predetermined electric storage capacity, the image quality of the image formed on the recording paper PP by the ink jet printer 1 is deteriorated.

In the present embodiment, it is assumed that the state of the inspection target discharge section DK is inspected based on the detection potential signal VX[m] detected from the inspection target discharge section DK when a drive target discharge section DD is driven by the drive signal Com. Here, the drive target discharge section DD is a discharge section D different from the inspection target discharge section DK. In the present embodiment, as an example, it is assumed that the drive target discharge section DD is a discharge section D adjacent to the inspection target discharge section DK.

Hereinafter, a series of processes executed in the ink jet printer 1 for inspecting the state of the inspection target discharge section DK is referred to as a discharge section inspection process. Specifically, the discharge section inspection process is a series of processes including an inspection of the state of the inspection target discharge section DK and a preparation process such as driving of the drive target discharge section DD to be executed for the inspection of the state of the inspection target discharge section DK.

When the discharge section inspection process is executed, the control unit 2 supplies the designation signal SI to the head unit 3. As a result, the control unit 2 designates the inspection target discharge section DK and the drive target discharge section DD from the discharge sections D[1] to D[M]. The control unit 2 controls the head unit 3 such that the drive target discharge section DD is driven by the drive signal Com and then the detection potential signal VX[m] detected from the inspection target discharge section DK is supplied to the detection circuit 33. In addition, when the discharge section inspection process is executed, the detection circuit 33 generates the detection signal SK[m] based on the detection potential signal VX[m] detected from the inspection target discharge section DK. When the discharge section inspection process is executed, the inspection unit 5 inspects the state of the discharge section D[m] driven as the inspection target discharge section DK based on the detection signal SK[m] supplied from the detection circuit 33.

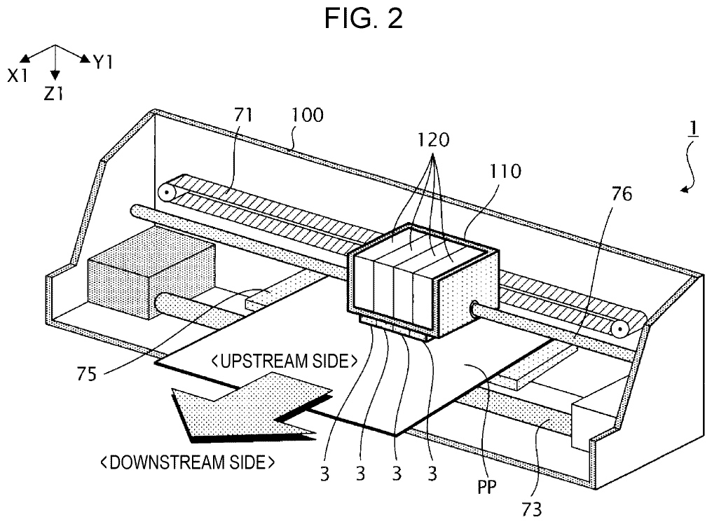

FIG. 2 is a perspective view illustrating an example of the schematic internal structure of the ink jet printer 1.

As illustrated in FIG. 2, in the present embodiment, it is assumed that the ink jet printer 1 is a serial printer. Specifically, when executing the printing process, the ink jet printer 1 discharges the ink from the discharge section D[m] while transporting the recording paper PP in an X1 direction and reciprocating the head unit 3 in a Y1 direction intersecting the X1 direction and a Y2 direction opposite to the Y1 direction, thereby forming dots Dt corresponding to the print data Img on the recording paper PP.

In the following, the X1 direction and an X2 direction opposite to the X1 direction are collectively referred to as an “X-axis direction”, the Y1 direction that intersects the X-axis direction and the Y2 direction opposite to the Y1 direction are collectively referred to as a “Y-axis direction”, and a Z1 direction that intersects the X-axis direction and the Y-axis direction and a Z2 direction opposite to the Z1 direction are collectively referred to as a “Z-axis direction”. In the present embodiment, as an example, a description will be made by assuming that the X-axis direction, the Y-axis direction, and the Z-axis direction are orthogonal to each other. Meanwhile, the present disclosure is not limited to such an aspect. The X-axis direction, the Y-axis direction, and the Z-axis direction may intersect each other. In the present embodiment, the Z1 direction is a direction in which the ink is discharged from the discharge section D[m].

As illustrated in FIG. 2, the ink jet printer 1 according to the present embodiment includes a housing 100 and a carriage 110 capable of reciprocating in the Y-axis direction in the housing 100 and having four head units 3 mounted thereon.

In the present embodiment, as illustrated in FIG. 2, it is assumed that the carriage 110 stores four ink cartridges 120 corresponding to four color inks of cyan, magenta, yellow, and black on a one-to-one basis. Further, in the present embodiment, as described above, it is assumed that the ink jet printer 1 includes four head units 3 corresponding to the four ink cartridges 120 on a one-to-one basis. Each discharge section D[m] receives the ink supplied from the ink cartridge 120 corresponding to the head unit 3 provided with the discharge section D[m]. As a result, each discharge section D[m] can fill the inside with the supplied ink and discharge the ink filling the inside of the discharge section D[m] from the nozzle N provided in the discharge section D[m]. The ink cartridge 120 may be provided outside the carriage 110.

Further, as described above, the ink jet printer 1 according to the present embodiment includes the transport unit 7. As illustrated in FIG. 2, the transport unit 7 includes a carriage transport mechanism 71 for reciprocating the carriage 110 in the Y-axis direction, a carriage guide shaft 76 for supporting the carriage 110 to reciprocate in the Y-axis direction, a medium transport mechanism 73 for transporting the recording paper PP, and a platen 75 provided in the Z1 direction from the carriage 110. Therefore, when executing the printing process, the transport unit 7 reciprocates the head unit 3 in the Y-axis direction along the carriage guide shaft 76 together with the carriage 110 by the carriage transport mechanism 71, to transport the recording paper PP on the platen 75 in the X1 direction by the medium transport mechanism 73, so that the relative position with respect to the head unit 3 of the recording paper PP is changed, and the ink can land on the entire recording paper PP.

FIG. 3 is a schematic partial sectional view of the recording head 32 in which the recording head 32 is cut to include the discharge section D[m].

As illustrated in FIG. 3, the discharge section D[m] includes the piezoelectric element PZ[m], a cavity CV filled with ink, a nozzle N that communicates with the cavity CV, and a vibrating plate 321. The discharge section D[m] discharges the ink in the cavity CV from the nozzle N by driving the piezoelectric element PZ[m] by the supply drive signal Vin[m]. The cavity CV is a space defined by a cavity plate 324, a nozzle plate 323 in which the nozzle N is formed, and the vibrating plate 321. The cavity CV communicates with a reservoir 325 via an ink supply port 326. The reservoir 325 communicates with the ink cartridge 120 corresponding to the discharge section D[m] via the common liquid chamber 327. The piezoelectric element PZ[m] includes the upper electrode Zu[m], a lower electrode Zd[m], and a piezoelectric body Zm[m] provided between the upper electrode Zu[m] and the lower electrode Zd[m]. The lower electrode Zd[m] is electrically coupled to a power supply line Ld set to a predetermined potential VBS. When the supply drive signal Vin[m] is supplied to the upper electrode Zu[m] and a voltage is applied between the upper electrode Zu[m] and the lower electrode Zd[m], the piezoelectric element PZ[m] is displaced in the Z1 direction or the Z2 direction in accordance with the applied voltage, and as a result, the piezoelectric element PZ[m] vibrates. The lower electrode Zd[m] is joined to the vibrating plate 321. Therefore, when the piezoelectric element PZ[m] is driven by the supply drive signal Vin[m] and vibrates, the vibrating plate 321 also vibrates. The vibration of the vibrating plate 321 changes the volume of the cavity CV and the pressure in the cavity CV, and the ink that fills the cavity CV is discharged from the nozzle N.

In the present embodiment, as an example, it is assumed that the flow paths such as the cavities CV provided in each of the M discharge sections D[1] to D[M] included in the head unit 3 communicate with the common liquid chamber 327 that stores the ink. Therefore, in the present embodiment, among the M discharge sections D[1] to D[M] included in the head unit 3, the vibration generated in one discharge section D is propagated to the other discharge sections D via the ink stored in the common liquid chamber 327.

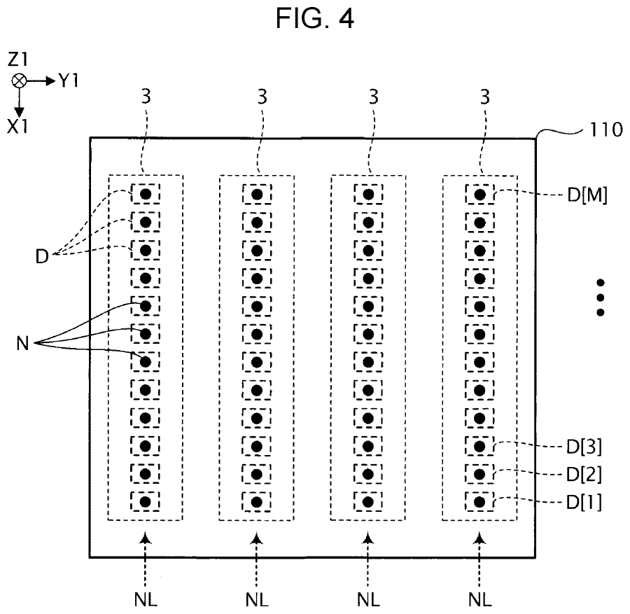

FIG. 4 is an explanatory diagram for describing an example of a disposition of the four head units 3 included in the ink jet printer 1 and the total of 4M nozzles N provided in the four head units 3 when the ink jet printer 1 is viewed in a plan view in the Z2 direction. As illustrated in FIG. 4, the head unit 3 is provided with a nozzle row Ln. Here, the nozzle row Ln is a plurality of nozzles N provided to extend in a row in a predetermined direction.

In the present embodiment, it is assumed as an example that each nozzle row Ln is configured with M nozzles N disposed to extend in the X-axis direction. Specifically, in the present embodiment, it is assumed that M nozzles N corresponding to the M discharge sections D[1] to D[M] are disposed side by side in order from the X1 direction to the X2 direction. That is, in the present embodiment, it is assumed that the nozzle N included in the discharge section D[m0] is disposed to be adjacent to the nozzle N included in the discharge section D[m0−1] in the X2 direction of the nozzle N included in the discharge section D[m0−1], and the nozzle N included in the discharge section D[m0+1] is disposed to be adjacent to the nozzle N included in the discharge section D[m0] in the X2 direction of the nozzle N included in the discharge section D[m0]. In other words, in he present embodiment, it is assumed that the discharge section D[m0] is disposed to be adjacent to the discharge section D[m0−1] in the X2 direction of the discharge section D[m0−1], and the discharge section D[m0+1] is disposed to be adjacent to the discharge section D[m0] in the X2 direction of the discharge section D[m0]. In this case, the variable m0 is a natural number that satisfies “2≤m0≤M−1”.

### 2. Overview of Head Unit

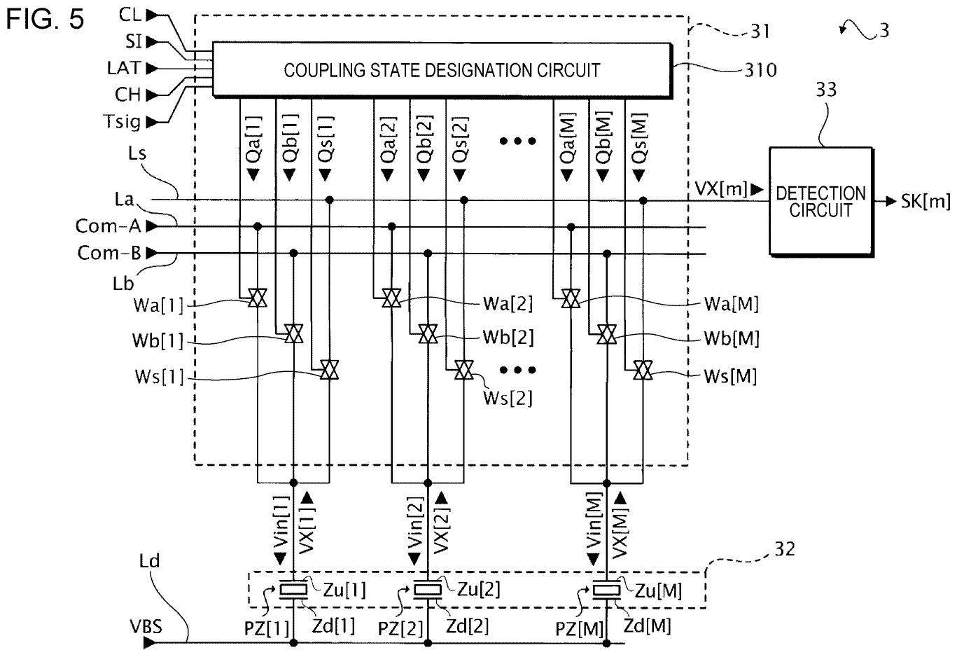

Hereinafter, an overview of the head unit 3 will be described with reference to FIGS. 5 to 7.

FIG. 5 is a block diagram illustrating an example of a configuration of the head unit 3.

As illustrated in FIG. 5, the head unit 3 includes the supply circuit 31, the recording head 32, and the detection circuit 33. In addition, the head unit 3 includes a wire La through which the drive signal Com-A is supplied from the drive signal generation unit 4, a wire Lb through which the drive signal Com-B is supplied from the drive signal generation unit 4, the power supply line Ld set to the potential VBS, and a wire Ls for supplying the detection potential signal VX[m] to the detection circuit 33.

The supply circuit 31 includes M switches Wa[1] to Wa[M] corresponding to the M discharge sections D[1] to D[M] on a one-to-one basis, M switches Wb[1] to Wb[M] corresponding to the M discharge sections D[1] to D[M] on a one-to-one basis, M switches Ws[1] to Ws[M] corresponding to the M discharge sections D[1] to D[M] on a one-to-one basis, and a coupling state designation circuit 310 that designates the coupling state of each switch.

The coupling state designation circuit 310 generates a coupling state designation signal Qa[m] that designates on/off of the switch Wa[m], a coupling state designation signal Qb[m] that designates on/off of the switch Wb[m], and a coupling state designation signal Qs[m] that designates on/off of the switch Ws[m], based on the designation signal SI, a latch signal LAT, a change signal CH, a period designation signal Tsig, and a clock signal CL supplied from the control unit 2.

The switch Wa[m] switches between conduction and non-conduction between the wire La and the upper electrode Zu[m] of the piezoelectric element PZ[m] based on the coupling state designation signal Qa[m]. In the present embodiment, the switch Wa[m] is turned on when the coupling state designation signal Qa[m] is at a high level, and is turned off when the coupling state designation signal Qa[m] is at a low level. When the switch Wa[m] is turned on, the drive signal Com-A supplied to the wire La is supplied to the upper electrode Zu[m] of the discharge section D[m] as the supply drive signal Vin[m].

The switch Wb[m] switches between conduction and non-conduction between the wire Lb and the upper electrode Zu[m] of the piezoelectric element PZ[m] based on the coupling state designation signal Qb[m]. In the present embodiment, the switch Wb[m] is turned on when the coupling state designation signal Qb[m] is at a high level, and is turned off when the coupling state designation signal Qb[m] is at a low level. When the switch Wb[m] is turned on, the drive signal Com-B supplied to the wire Lb is supplied as the supply drive signal Vin[m] to the upper electrode Zu[m] of the discharge section D[m].

The switch Ws[m] switches between conduction and non-conduction between the wire Ls and the upper electrode Zu[m] of the piezoelectric element PZ[m] based on the coupling state designation signal Qs[m]. In the present embodiment, the switch Ws[m] is turned on when the coupling state designation signal Qs[m] is at a high level, and is turned off when the coupling state designation signal Qs[m] is at a low level. When the switch Ws[m] is turned on, the potential of the upper electrode Zu[m] provided in the discharge section D[m] is supplied to the detection circuit 33 via the wire Ls as the detection potential signal VX[m].

In the present embodiment, the detection circuit 33 generates the detection signal SK[m] having a waveform corresponding to the waveform of the detection potential signal VX[m] based on the detection potential signal VX[m] supplied from the wire Ls. Specifically, the detection circuit 33 generates a signal that is a signal obtained by amplifying the detection potential signal VX[m] and is obtained by removing the noise component from the detection potential signal VX[m], and outputs the generated signal as the detection signal SK[m].

In the present embodiment, when the ink jet printer 1 executes the printing process, a plurality of unit printing periods TP are set as an operation period of the ink jet printer 1. The ink jet printer 1 can drive each discharge section D for the printing process in each unit printing period TP. In the following, the drive signal Com-A supplied to the head unit 3 in the unit printing period TP may be referred to as a printing drive signal Com-AP, and the drive signal Com-B supplied to the head unit 3 in the unit printing period TP may be referred to as a printing drive signal Com-BP.

In addition, in the present embodiment, when the ink jet printer 1 executes the discharge section inspection process, a plurality of unit inspection periods TX or a plurality of unit inspection periods TY are set as the operation period of the ink jet printer 1. In the following, the drive signal Com-A supplied to the head unit 3 in the unit inspection period TX may be referred to as an inspection drive signal Com-AX, and the drive signal Com-B supplied to the head unit 3 in the unit inspection period TX may be referred to as an inspection drive signal Com-BX. In addition, the drive signal Com-A supplied to the head unit 3 in the unit inspection period TY may be referred to as an inspection drive signal Com-AY, and the drive signal Com-B supplied to the head unit 3 in the unit inspection period TY may be referred to as an inspection drive signal Com-BY.

In addition, in the following, the unit printing period TP, the unit inspection period TX, and the unit inspection period TY may be collectively referred to as a unit operation period TT.

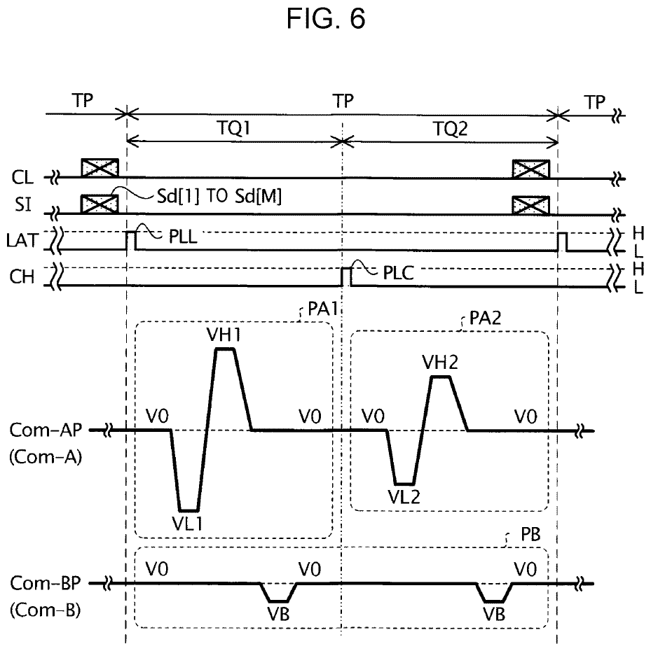

FIG. 6 is a timing chart illustrating an example of various signals such as the drive signal Com supplied to the head unit 3 in each unit printing period TP.

As illustrated in FIG. 6, when the printing process is executed, the control unit 2 outputs the latch signal LAT having a plurality of pulses PLL. Accordingly, the control unit 2 defines the unit printing period TP as a period from the rise of the pulse PLL to the rise of the next pulse PLL.

Further, when the printing process is executed, the control unit 2 outputs the change signal CH having the pulse PLC in the unit printing period TP. As a result, the control unit 2 divides the unit printing period TP into a control period TQ1 from the rise of the pulse PLL to the rise of the pulse PLC and a control period TQ2 from the rise of the pulse PLC to the rise of the pulse PLL.

As illustrated in FIG. 6, the designation signal SI includes M individual designation signals Sd[1] to Sd[M] corresponding to the M discharge sections D[1] to D[M] on a one-to-one basis. The individual designation signal Sd[m] designates an aspect of the driving of the discharge section D[m] in each unit operation period TT (that is, each unit printing period TP, each unit inspection period TX, or each unit inspection period TY) when the ink jet printer 1 executes the printing process or the discharge section inspection process. When the printing process is executed, the control unit 2 supplies the designation signal SI including the M individual designation signals Sd[1] to Sd[M] to the coupling state designation circuit 310 in synchronization with the clock signal CL before each unit printing period TP. The coupling state designation circuit 310 generates the coupling state designation signal Qa[m], the coupling state designation signal Qb[m], and the coupling state designation signal Qs[m] based on the individual designation signal Sd[m] in each unit printing period TP.

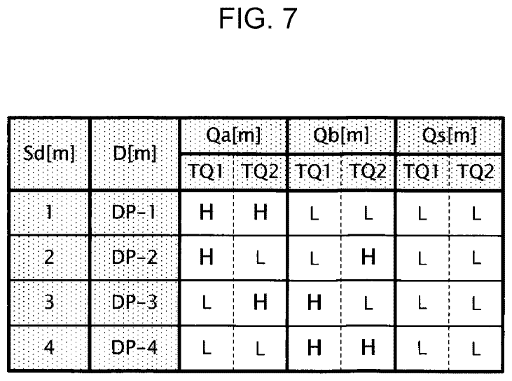

In the present embodiment, the individual designation signal Sd[m] can take any one value among four values, a value of “1” that designates the discharge section D[m] as a large dot formation discharge section DP-1, a value of “2” that designates the discharge section D[m] as a medium dot formation discharge section DP-2, a value of “3” that designates the discharge section D[m] as a small dot formation discharge section DP-3, and a value of “4” that designates the discharge section D[m] as a dot non-formation discharge section DP-4, in the unit printing period TP in which the printing process is executed (refer to FIG. 7 described later).

In this case, the large dot formation discharge section DP-1 is a discharge section D that forms large dots in the unit printing period TP. The medium dot formation discharge section DP-2 is the discharge section D that forms the medium dot in the unit printing period TP. The small dot formation discharge section DP-3 is a discharge section D that forms small dots in the unit printing period TP. The dot non-formation discharge section DP-4 is a discharge section D that does not form dots in the unit printing period TP.

As illustrated in FIG. 6, the printing drive signal Com-AP has a waveform PA1 and a waveform PA2 provided for each unit printing period TP. The waveform PA1 is a waveform provided in the control period TQ1 of the unit printing period TP and returning to a reference potential V0 via a potential VL1 lower than the reference potential V0 and a potential VH1 higher than the reference potential V0 from the reference potential V0. When the supply drive signal Vin[m] having the waveform PA1 is supplied to the discharge section D[m], the waveform PA1 is determined such that the ink corresponding to an ink amount ξ1 is discharged from the discharge section D[m]. The waveform PA2 is a waveform provided in the control period TQ2 of the unit printing period TP and returning to the reference potential V0 via a potential VL2 lower than the reference potential V0 and a potential VH2 higher than the reference potential V0 from the reference potential V0. When the supply drive signal Vin[m] having the waveform PA2 is supplied to the discharge section D[m], the waveform PA2 is determined such that the ink corresponding to an ink amount ξ2 is discharged from the discharge section D[m]. In the present embodiment, it is assumed that the large dot is formed of the ink having the total amount of the ink amount ξ1 and the ink amount ξ2, the medium dot is formed of the ink having the ink amount ξ1, and the small dot is formed of the ink having the ink amount ξ2.

In the present embodiment, as an example, it is assumed that, when the potential of the supply drive signal Vin[m] supplied to the discharge section D[m] is high, the volume of the cavity CV provided in the discharge section D[m] is small as compared with the case of a low potential. Therefore, when the discharge section D[m] is driven by the supply drive signal Vin[m] having a waveform PA1 or a waveform PA2, the potential of the supply drive signal Vin[m] changes from a low potential to a high potential, thereby the ink in the discharge section D[m] being discharged from the nozzle N.

As illustrated in FIG. 6, the printing drive signal Com-BP has a waveform PB provided for each unit printing period TP. Here, the waveform PB is a waveform including two micro-vibration waveforms of a micro-vibration waveform provided in the control period TQ1 of each unit printing period TP and returning to the reference potential V0 from the reference potential V0 via the potential VB lower than the reference potential V0, and a micro-vibration waveform provided in the control period TQ2 of each unit printing period TP and returning to the reference potential V0 from the reference potential V0 via the potential VB lower than the reference potential V0. In the present embodiment, the waveform PB is provided so that the ink is not discharged from the discharge section D[m] even when the discharge section D[m] is driven by the printing drive signal Com-BP.

FIG. 7 is an explanatory diagram illustrating an example of the operation of the coupling state designation circuit 310 in the unit printing period TP.

As illustrated in FIG. 7, when the individual designation signal Sd[m] indicates the value “1” that designates the discharge section D[m] as the large dot formation discharge section DP-1 in the unit printing period TP, the coupling state designation circuit 310 maintains the coupling state designation signal Qa[m] at a high level throughout the unit printing period TP. In this case, the switch Wa[m] is turned on over the unit printing period TP. Therefore, the discharge section D[m] is driven by the supply drive signal Vin[m] having the waveform PA1 and the waveform PA2 in the unit printing period TP, and discharges the total amount of ink of the ink amount ξ1 and the ink amount ξ2, which is an amount corresponding to a large dot.

In addition, when the individual designation signal Sd[m] indicates the value “2” that designates the discharge section D[m] as the medium dot formation discharge section DP-2 in the unit printing period TP, the coupling state designation circuit 310 maintains the coupling state designation signal Qa[m] at a high level in the control period TQ1 and maintains the coupling state designation signal Qb[m] at a high level in the control period TQ2. In this case, the switch Wa[m] is turned on in the control period TQ1, and the switch Wb[m] is turned on in the control period TQ2. Therefore, the discharge section D[m] is driven by the supply drive signal Vin[m] having the waveform PA1 in the control period TQ1, and discharges the ink having the ink amount ξ1, which is an amount corresponding to the medium dot.

In addition, when the individual designation signal Sd[m] indicates the value “3” that designates the discharge section D[m] as the small dot formation discharge section DP-3 in the unit printing period TP, the coupling state designation circuit 310 maintains the coupling state designation signal Qb[m] at a high level in the control period TQ1 and maintains the coupling state designation signal Qa[m] at a high level in the control period TQ2. In this case, the switch Wa[m] is turned on in the control period TQ2. Therefore, the discharge section D[m] is driven by the supply drive signal Vin[m] having the waveform PA2 in the control period TQ2, and discharges the ink having the ink amount ξ2, which is an amount corresponding to the small dot.

Further, when the individual designation signal Sd[m] indicates the value “4” that designates the discharge section D[m] as the dot non-formation discharge section DP-4 in the unit printing period TP, the coupling state designation circuit 310 maintains the coupling state designation signal Qb[m] at a high level throughout the unit printing period TP. In this case, the switch Wb[m] is turned on over the unit printing period TP. Therefore, the discharge section D[m] is driven not to discharge the ink by the supply drive signal Vin[m] having the micro-vibration waveform in the unit printing period TP.

### 3. Overview of Discharge Section Inspection Process

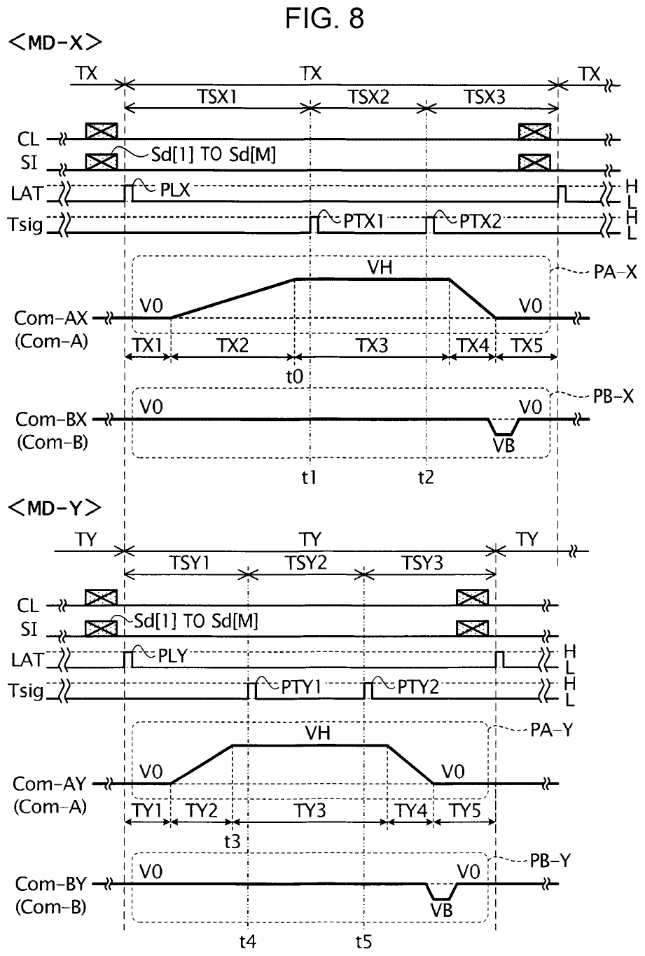

Hereinafter, an overview of the discharge section inspection process will be described with reference to FIGS. 8 to 18.

### 3.1. Inspection Mode Md

In the present embodiment, as an example, it is assumed that the ink jet printer 1 can execute the discharge section inspection process in two inspection modes MD including a normal inspection mode MD-X and a high-speed inspection mode MD-Y.

Here, the normal inspection mode MD-X is an inspection mode MD for performing an inspection of the state of the inspection target discharge section DK in a state where the cavity CV of the inspection target discharge section DK and the cavity CV of the drive target discharge section DD are filled with ink. Specifically, the normal inspection mode MD-X is an inspection mode MD for inspecting the state of the inspection target discharge section DK in a state where the ink fills each of the cavities CV of the discharge sections D[1] to D[M]. For example, the normal inspection mode MD-X may be the inspection mode MD used in the discharge section inspection process performed by the user of the ink jet printer 1 after the product shipment of the ink jet printer 1, in a state where the ink cartridge 120 is mounted on the ink jet printer 1 and the ink is supplied from the ink cartridge 120 to the cavity CV.

In addition, the high-speed inspection mode MD-Y is an inspection mode MD for performing an inspection of the state of the inspection target discharge section DK in a state where the cavity CV of the inspection target discharge section DK and the cavity CV of the drive target discharge section DD are not filled with ink. Specifically, the high-speed inspection mode MD-Y is an inspection mode MD for inspecting the state of the inspection target discharge section DK in a state where the ink does not fill each of the cavities CV of the discharge sections D[1] to D[M]. For example, the high-speed inspection mode MD-Y may be the inspection mode MD used in the discharge section inspection process performed in a state where the ink does not fill each of the cavities CV of the discharge sections D[1] to D[M] before the product shipment of the ink jet printer 1.

In the present embodiment, it is assumed that the high-speed inspection mode MD-Y is the inspection mode MD used in the discharge section inspection process in a state where the cavity CV of the inspection target discharge section DK and the cavity CV of the drive target discharge section DD are not filled with ink. However, the present disclosure is not limited to such an aspect. The high-speed inspection mode MD-Y may be the inspection mode MD used in the discharge section inspection process in a state where a specific type of liquid fills the cavities CV of the inspection target discharge section DK and the drive target discharge section DD.

Here, the specific type of liquid is a liquid having a lower viscosity than the liquid filling the cavities CV of the inspection target discharge section DK and the drive target discharge section DD in the normal inspection mode MD-X. Specifically, the specific type of liquid may be, for example, a liquid that is not used for forming an image in the printing process executed by the ink jet printer 1. More specifically, the specific type of liquid may be, for example, a storage liquid for protecting the discharge section D of the ink jet printer 1 before shipment of the ink jet printer 1, an anti-freezing liquid for preventing the freezing of the discharge section D of the ink jet printer 1 before shipment of the ink jet printer 1, or a cleaning liquid for cleaning the flow path communicating with the discharge section D of the ink jet printer 1.

In the present embodiment, the control unit 2 selects the inspection mode MD when the discharge section inspection process is executed, based on the presence or absence of mounting of the ink cartridge 120 on the carriage 110 and the type of the ink cartridge 120 mounted on the carriage 110. Meanwhile, the present disclosure is not limited to such an aspect. The control unit 2 may select the inspection mode MD when the discharge section inspection process is executed based on an operation of the user of the ink jet printer 1 or an operation of a setting operator of the ink jet printer 1.

### 3.2. Various Signals Related to Discharge Section Inspection Process

FIG. 8 is a timing chart illustrating an example of various signals such as the drive signal Com supplied to the head unit 3 in the unit inspection period TX and the unit inspection period TY.

As illustrated in FIG. 8, when the discharge section inspection process in the normal inspection mode MD-X is executed, the control unit 2 outputs the latch signal LAT having a plurality of pulses PLX. As a result, the control unit 2 defines the unit inspection period TX as a period from the rise of the pulse PLX to the rise of the next pulse PLX. Further, the control unit 2 outputs the latch signal LAT having a plurality of pulses PLY when the discharge section inspection process is executed in the high-speed inspection mode MD-Y. As a result, the control unit 2 defines the unit inspection period TY, which is a period shorter than the unit inspection period TX, as a period from the rise of the pulse PLY to the rise of the next pulse PLY.

In the following, the unit inspection period TX and the unit inspection period TY may be collectively referred to as a unit inspection period TXY.

As illustrated in FIG. 8, when the discharge section inspection process in the normal inspection mode MD-X is executed, the control unit 2 outputs the period designation signal Tsig having the pulse PTX1 and the pulse PTX2. As a result, the control unit 2 divides the unit inspection period TX into a control period TSX1 from the rise of the pulse PLX to the rise of the pulse PTX1, a control period TSX2 from the rise of the pulse PTX1 to the rise of the pulse PTX2, and a control period TSX3 from the rise of the pulse PTX2 to the rise of the pulse PLX.

In addition, when the discharge section inspection process is executed in the high-speed inspection mode MD-Y, the control unit 2 outputs the period designation signal Tsig having the pulse PTY1 and the pulse PTY2. As a result, the control unit 2 divides the unit inspection period TY into the control period TSY1 from the rise of the pulse PLY to the rise of the pulse PTY1, the control period TSY2 from the rise of the pulse PTY1 to the rise of the pulse PTY2, and the control period TSY3 from the rise of the pulse PTY2 to the rise of the pulse PLY.

In the present embodiment, as an example, it is assumed that the control period TSX1 has a time length longer than the time length of the control period TSY1, the control period TSX2 and the control period TSY2 have the same time length, and the control period TSX3 and the control period TSY3 have the same time length. In the following, the control period TSX1 and the control period TSY1 may be collectively referred to as a control period TS1, the control period TSX2 and the control period TSY2 may be collectively referred to as a control period TS2, and the control period TSX3 and the control period TSY3 may be collectively referred to as a control period TS3.

As illustrated in FIG. 8, when the discharge section inspection process is executed in the normal inspection mode MD-X, the control unit 2 controls the drive signal generation unit 4 such that the inspection drive signal Com-AX is supplied as the drive signal Com-A and the inspection drive signal Com-BX is supplied as the drive signal Com-B.

Further, when the discharge section inspection process is executed in the high-speed inspection mode MD-Y, the control unit 2 controls the drive signal generation unit 4 such that the inspection drive signal Com-AY is supplied as the drive signal Com-A and the inspection drive signal Com-BY is supplied as the drive signal Com-B.

As illustrated in FIG. 8, the inspection drive signal Com-AX has a waveform PA-X provided in the unit inspection period TX. Here, the waveform PA-X is a waveform that maintains the reference potential V0 in a control period TX1 in the unit inspection period TX, changes in potential from the reference potential V0 to the drive potential VH in a control period TX2 following the control period TX1 in the unit inspection period TX, maintains the drive potential VH in a control period TX3 following the control period TX2 in the unit inspection period TX, changes in potential from the drive potential VH to the reference potential V0 in a control period TX4 following the control period TX3 in the unit inspection period TX, and maintains the reference potential V0 in a control period TX5 following the control period TX4 in the unit inspection period TX. Among these, the control period TX1 is included in the control period TSX1, starts at the same time as the start of the control period TSX1, and ends before the end of the control period TSX1. The control period TX2 is included in the control period TSX1, is started after the start of the control period TSX1, and ends before the end of the control period TSX1. The control period TX3 includes a part of the control period TSX1, the entire control period TSX2, and a part of the control period TSX3, starts after the start of the control period TSX1 and before the start of the control period TSX2, and ends after the end of the control period TSX2 and before the end of the control period TSX3. That is, the control period TSX2 is included in the control period TX3. The control period TX4 is included in the control period TSX3, is started after the start of the control period TSX3, and ends before the end of the control period TSX3. The control period TX5 is included in the control period TSX3, is started after the start of the control period TSX3, and ends at the same time as the end of the control period TSX3.

In the present embodiment, the time length of the control period TX2 is longer than the time length of the control period TX4.

In addition, in the present embodiment, a case where the drive potential VH is a potential higher than the reference potential V0 is assumed, but the present disclosure is not limited to such an aspect. The drive potential VH may be a lower potential than the reference potential V0. In addition, in the present embodiment, it is assumed that the waveform PA-X maintains the reference potential V0 in the control period TX1, but the present disclosure is not limited to such an aspect. The waveform PA-X only needs to be a waveform such that the potential at the start and end of the control period TX1 is the reference potential V0. In addition, in the present embodiment, it is assumed that the waveform PA-X maintains the reference potential V0 in the control period TX5, but the present disclosure is not limited to such an aspect. The waveform PA-X only needs to be a waveform such that the potential at the start and end of the control period TX5 is the reference potential V0.

In addition, the inspection drive signal Com-BX has a waveform PB-X provided in the unit inspection period TX. Here, in the waveform PB-X, the reference potential V0 is maintained in the control period TSX1 and the control period TSX2 in the unit inspection period TX, and the micro-vibration waveform is provided in the control period TSX3 in the unit inspection period TX. As described above, the micro-vibration waveform is a waveform that starts from the reference potential V0, passes through the potential VB lower than the reference potential V0, and returns to the reference potential V0.

As illustrated in FIG. 8, the inspection drive signal Com-AY has a waveform PA-Y provided in the unit inspection period TY. Here, the waveform PA-Y is a waveform that maintains the reference potential V0 in a control period TY1 in the unit inspection period TY, changes in potential from the reference potential V0 to the drive potential VH in a control period TY2 following the control period TY1 in the unit inspection period TY, maintains the drive potential VH in a control period TY3 following the control period TY2 in the unit inspection period TY, changes in potential from the drive potential VH to the reference potential V0 in a control period TY4 following the control period TY3 in the unit inspection period TY, and maintains the reference potential V0 in a control period TY5 following the control period TY4 in the unit inspection period TY. Among these, the control period TY1 is included in the control period TSY1, starts at the same time as the start of the control period TSY1, and ends before the end of the control period TSY1. The control period TY2 is included in the control period TSY1, is started after the start of the control period TSY1, and ends before the end of the control period TSY1. The control period TY3 includes a part of the control period TSY1, the entire control period TSY2, and a part of the control period TSY3, starts after the start of the control period TSY1 and before the start of the control period TSY2, and ends after the end of the control period TSY2 and before the end of the control period TSY3. That is, the control period TSY2 is included in the control period TY3. The control period TY4 is included in the control period TSY3, and is started after the start of the control period TSY3 and ended before the end of the control period TSY3. The control period TY5 is included in the control period TSY3, is started after the start of the control period TSY3, and ends at the same time as the end of the control period TSY3.

In the present embodiment, the time length of the control period TY2 is shorter than the time length of the control period TX2. In addition, in the present embodiment, the time length of the control period TY2 is longer than the time length of the control period TY4. Meanwhile, the present disclosure is not limited to such an aspect. The time length of the control period TY2 may be equal to or less than the time length of the control period TY4.

In addition, in the present embodiment, it is assumed that the waveform PA-Y maintains the reference potential V0 in the control period TY1, but the present disclosure is not limited to such an aspect. The waveforms PA-Y only need to be waveforms such that the potentials at the start and end of the control period TY1 are the reference potential V0. In addition, in the present embodiment, it is assumed that the waveform PA-Y maintains the reference potential V0 in the control period TY5, but the present disclosure is not limited to such an aspect. The waveforms PA-Y only need to be waveforms such that the potentials at the start and end of the control period TY5 are the reference potential V0.

In addition, the inspection drive signal Com-BY has a waveform PB-Y provided in the unit inspection period TY. Here, the waveform PB-Y maintains the reference potential V0 in the control period TSY1 and the control period TSY2 in the unit inspection period TY, and the micro-vibration waveform is provided in the control period TSY3 in the unit inspection period TY. As described above, the micro-vibration waveform is a waveform that starts from the reference potential V0, passes through the potential VB lower than the reference potential V0, and returns to the reference potential V0.

In the present embodiment, it is assumed that the time length of the unit inspection period TX is longer than the time length of the unit printing period TP and the time length of the unit inspection period TY is equal to the time length of the unit printing period TP. Meanwhile, the present disclosure is not limited to such an aspect. For example, the time length of the unit inspection period TX may be the same as the time length of the unit printing period TP. In addition, the time length of the unit inspection period TY may be shorter than the time length of the unit printing period TP, or may be longer than the time length of the unit printing period TP. The time length of the unit inspection period TX may be equal to or longer than the time length of the unit inspection period TY.

In the following, the inspection drive signal Com-AX and the inspection drive signal Com-AY may be collectively referred to as an inspection drive signal Com-AXY, and the inspection drive signal Com-BX and the inspection drive signal Com-BY may be collectively referred to as an inspection drive signal Com-BXY. In addition, in the following, the waveform PA-X and the waveform PA-Y may be collectively referred to as a waveform PA-XY, and the waveform PB-X and the waveform PB-Y may be collectively referred to as a waveform PB-XY.

As illustrated in FIG. 8, when the discharge section inspection process is executed, the control unit 2 supplies the designation signal SI including the M individual designation signals Sd[1] to Sd[M] to the coupling state designation circuit 310 in synchronization with the clock signal CL before each unit inspection period TXY (unit inspection period TX or unit inspection period TY). The coupling state designation circuit 310 generates the coupling state designation signal Qa[m], the coupling state designation signal Qb[m], and the coupling state designation signal Qs[m] based on the individual designation signal Sd[m] in each unit inspection period TXY.

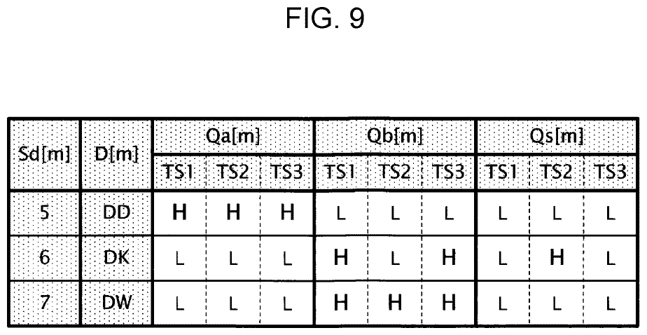

FIG. 9 is an explanatory diagram illustrating an example of the operation of the coupling state designation circuit 310 in the unit inspection period TXY (unit inspection period TX or unit inspection period TY).

As illustrated in FIG. 9, the individual designation signal Sd[m] can take any one value among three values, that is, a value “5” for designating the discharge section D[m] as the drive target discharge section DD, a value “6” for designating the discharge section D[m] as the inspection target discharge section DK, and a value “7” for designating the discharge section D[m] as a standby discharge section DW, in the unit inspection period TXY (the unit inspection period TX or the unit inspection period TY) during which the discharge section inspection process is executed.

Here, the drive target discharge section DD is the discharge section D that is the target of the driving in the discharge section inspection process as described above. The inspection target discharge section DK is the discharge section D that is the inspection target in the discharge section inspection process as described above. As described above, in the present embodiment, it is assumed that the inspection target discharge section DK and the drive target discharge section DD are adjacent to each other. Further, the standby discharge section DW is a discharge section D other than the inspection target discharge section DK and the drive target discharge section DD among the M discharge sections D[1] to D[M] included in the head unit 3.

As illustrated in FIG. 9, when the individual designation signal Sd[m] indicates the value “5” that designates the discharge section D[m] as the drive target discharge section DD in the unit inspection period TXY, the coupling state designation circuit 310 maintains the coupling state designation signal Qa[m] at a high level over the unit inspection period TXY. In this case, the switch Wa[m] is turned on over the unit inspection period TXY. Therefore, the discharge section D[m] is driven by the supply drive signal Vin[m] having the waveform PA-X or the waveform PA-Y in the unit inspection period TXY, and the potential in the control period TS2 (the control period TSX2 or the control period TSY2) is set to the drive potential VH.

Further, when the individual designation signal Sd[m] indicates the value “7” that designates the discharge section D[m] as the standby discharge section DW in the unit inspection period TXY, the coupling state designation circuit 310 maintains the coupling state designation signal Qb[m] at a high level throughout the unit inspection period TXY. In this case, the switch Wb[m] is turned on over the unit inspection period TXY. Therefore, the discharge section D[m] is driven by the supply drive signal Vin[m] having the waveform PB-X or the waveform PB-Y in the unit inspection period TXY, and the potential in the control period TS2 (the control period TSX2 or the control period TSY2) is set to the reference potential V0.

As illustrated in FIG. 9, when the individual designation signal Sd[m] indicates the value “6” that designates the discharge section D[m] as the inspection target discharge section DK in the unit inspection period TXY, the coupling state designation circuit 310 maintains the coupling state designation signal Qb[m] at a high level in the control period TS1 and the control period TS3, and maintains the coupling state designation signal Qs[m] at a high level in the control period TS2. In this case, the switch Wb[m] is turned on in the control period TS1 and the control period TS3, and the switch Ws[m] is turned on in the control period TS2. Then, the detection circuit 33 detects the potential of the upper electrode Zu[m] included in the discharge section D[m] as the detection potential signal VX[m] via the switch Ws[m] in the control period TS2 (control period TSX2 or control period TSY2).

In the present embodiment, in each unit inspection period TXY, it is assumed that one discharge section D[m] among the M discharge sections D[1] to D[M] is designated as the inspection target discharge section DK, one discharge section D is designated as the drive target discharge section DD, and the remaining (M−2) discharge sections D are designated as the standby discharge sections DW. Meanwhile, the present disclosure is not limited to such an aspect. In each unit inspection period TXY, one discharge section D[m] among the M discharge sections D[1] to D[M] may be designated as the inspection target discharge section DK, some or all of the remaining (M−1) discharge sections D may be designated as the drive target discharge section DD, and the discharge section D that is not designated as the inspection target discharge section DK or the drive target discharge section DD may be designated as the standby discharge section DW.

### 3.3. Operation of Head Unit 3 in Discharge Section Inspection Process

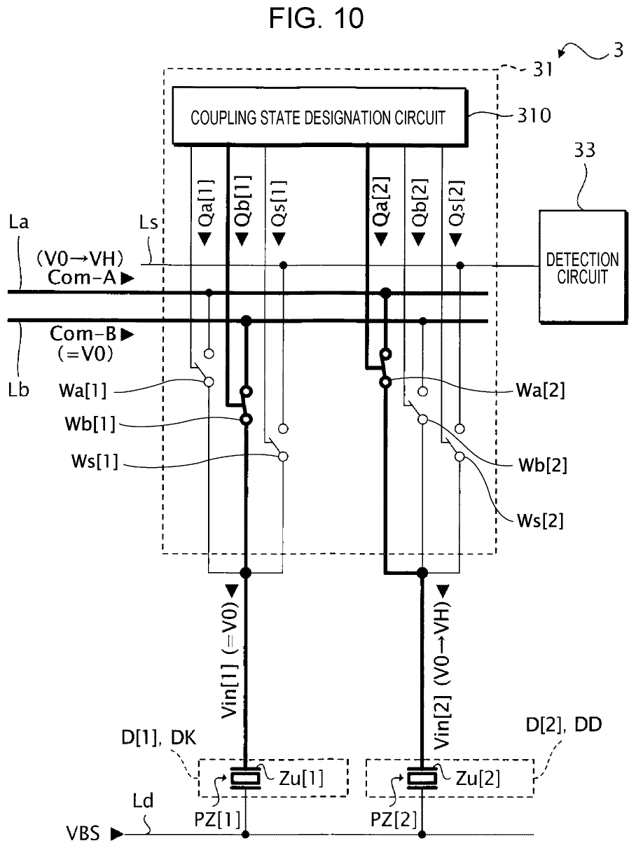

FIGS. 10 to 12 are explanatory diagrams illustrating an example of the operation of the head unit 3.

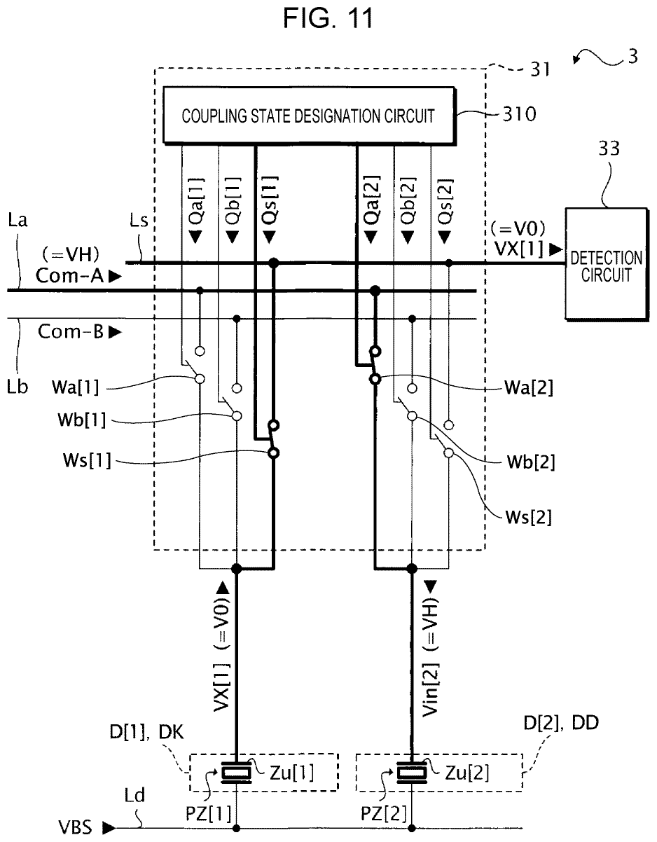

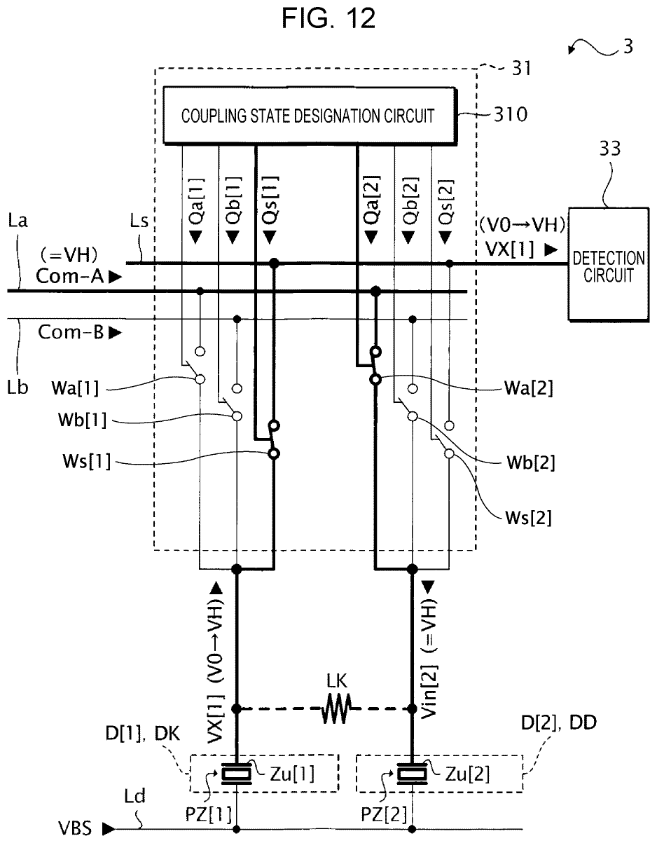

In the examples illustrated in FIGS. 10 to 12, for convenience of description, two discharge sections D[1] and D[2] among the M discharge sections D[1] to D[M] included in the head unit 3 are illustrated. In addition, in the examples illustrated in FIGS. 10 to 12, a case where the discharge section D[1] is designated as the inspection target discharge section DK and the discharge section D[2] is designated as the drive target discharge section DD is illustrated. In the example illustrated in FIG. 10, an example of the operation of the head unit 3 in the control period TS1 in the unit inspection period TXY is illustrated. In addition, in the example illustrated in FIG. 11, an example of the operation of the head unit 3 in the control period TS2 following the control period TS1 illustrated in FIG. 10, that is, a case where each of the M discharge sections D[1] to D[M] included in the head unit 3 has a predetermined electric storage capacity, is illustrated. In addition, in the example illustrated in FIG. 12, an example of the operation of the head unit 3 in the control period TS2 following the control period TS1 illustrated in FIG. 10, that is, a case is illustrated in which a short-circuit path LK is formed between the discharge section D[1] and the discharge section D[2] among the M discharge sections D[1] to D[M] included in the head unit 3, and the discharge section D[1] and the discharge section D[2] do not have a predetermined electric storage capacity.

As illustrated in FIG. 10, in the unit inspection period TXY, when the discharge section D[1] is designated as the inspection target discharge section DK and the discharge section D[2] is designated as the drive target discharge section DD, in the control period TS1 of the unit inspection period TXY, the upper electrode Zu[1] included in the discharge section D[1] and the wire Lb are electrically coupled to each other via the switch Wb[1], and the upper electrode Zu[2] included in the discharge section D[2] and the wire La are electrically coupled to each other via the switch Wa[2]. Therefore, in the control period TS1, the potential of the upper electrode Zu[1] is set to the reference potential V0 which is the potential of the inspection drive signal Com-BXY (inspection drive signal Com-BX or inspection drive signal Com-BY) in the control period TS1. In addition, in the control period TS1, the potential of the upper electrode Zu[2] changes from the reference potential V0 to the drive potential VH, similar to the potential change of the inspection drive signal Com-AXY (the inspection drive signal Com-AX or the inspection drive signal Com-AY) in the control period TS1.

As illustrated in FIG. 11, when the discharge section D[1] and the discharge section D[2] have a predetermined electric storage capacity, in the control period TS2 following the control period TS1 illustrated in FIG. 10, the upper electrode Zu[1] included in the discharge section D[1] and the wire Ls are electrically coupled to each other via the switch Ws[1], and the upper electrode Zu[2] included in the discharge section D[2] and the wire La are electrically coupled to each other via the switch Wa[2]. Therefore, in the control period TS2, the potential of the upper electrode Zu[2] is set to the drive potential VH which is the potential of the inspection drive signal Com-AXY in the control period TS2. In addition, in the control period TS2, the potential of the upper electrode Zu[1] maintains the reference potential V0 which is the potential set in the control period TS1, and the detection potential signal VX[1] indicating the reference potential V0 is supplied to the detection circuit 33 via the wire Ls.

As illustrated in FIG. 12, when the short-circuit path LK is formed between the upper electrode Zu[1] and the upper electrode Zu[2], at the start point of the control period TS2 following the control period TS1 illustrated in FIG. 10, the potential of the upper electrode Zu[1] is set to the reference potential V0, and the potential of the upper electrode Zu[2] is set to the drive potential VH. However, in the control period TS2, the potential of the upper electrode Zu[1] changes to approach the potential of the upper electrode Zu[2] as a result of the leak current flowing through the short-circuit path LK. That is, in the control period TS2, the potential of the upper electrode Zu[1] changes from the reference potential V0 to approach the drive potential VH. Therefore, in the control period TS2, the detection circuit 33 detects the detection potential signal VX[1] in which the potential changes to approach the drive potential VH from the reference potential V0.

### 3.4. Detection Potential Signal VX[m] in Discharge Section Inspection Process

In the present embodiment, the inspection unit 5 determines whether a potential change amount of the detection potential signal VX[m] in the control period TS2 is equal to or more than a threshold value dVth by using the detection signal SK[m] generated by the detection circuit 33 based on the detection potential signal VX[m]. Specifically, the inspection unit 5 determines whether the detection potential signal VX[m] is a potential equal to or more than a threshold potential Vth in the control period TS2 based on the detection signal SK[m]. Here, the threshold potential Vth is a potential obtained by adding the threshold value dVth to the reference potential V0.

Then, when the result of the determination is negative, that is, when the potential change amount of the detection potential signal VX[m] in the control period TS2 is less than the threshold value dVth, the inspection result signal SS[m] indicating a value (for example, “1”) corresponding to the determination result that the discharge section D[m] has the predetermined electric storage capacity is output. Meanwhile, when the result of the determination is positive, that is, when the potential change amount of the detection potential signal VX[m] in the control period TS2 is equal to or more than the threshold value dVth, the inspection result signal SS[m] indicating a value (for example, “0”) corresponding to the determination result that the discharge section D[m] does not have the predetermined electric storage capacity is output.

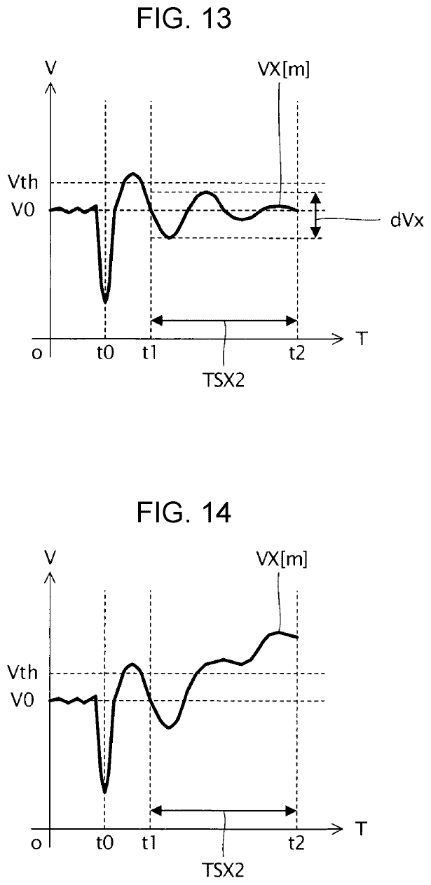

FIG. 13 is a diagram illustrating a change in potential of the upper electrode Zu[m] when the discharge section inspection process is executed in the normal inspection mode MD-X. In FIG. 13, it is assumed that the discharge section D[m] designated as the inspection target discharge section DK has a predetermined electric storage capacity.

As described above, the inspection drive signal Com-AX changes in potential from the reference potential V0 to the drive potential VH in the control period TX2, and maintains the drive potential VH in the control period TX3. That is, the potential change of the inspection drive signal Com-AX is stopped at a time t0 when the control period TX2 ends. Therefore, the vibration occurs in the drive target discharge section DD at the time t0. The vibration generated in the drive target discharge section DD at the time t0 propagates to the discharge section D[m] designated as the inspection target discharge section DK. When the discharge section D[m] vibrates, the piezoelectric element PZ[m] is displaced in response to the vibration. Therefore, as illustrated in FIG. 13, the potential of the detection potential signal VX[m] fluctuates at the time t0. Thereafter, the vibration remaining in the discharge section D[m] is attenuated, and the amplitude of the detection potential signal VX[m] is also attenuated.

In the present embodiment, the inspection unit 5 inspects the state of the discharge section D[m] based on the potential of the detection potential signal VX[m] in the control period TSX2. Specifically, the inspection unit 5 inspects the state of the discharge section D[m] by inspecting whether the potential of the detection potential signal VX[m] is equal to or more than the threshold potential Vth in the control period TSX2. In the present embodiment, in the discharge section inspection process in the normal inspection mode MD-X, when the discharge section D[m] designated as the inspection target discharge section DK has a predetermined electric storage capacity, it is assumed that the inclination of the waveform PA-X in the control period TX2 is set so that the amplitude dVx of the detection potential signal VX[m] is less than the threshold value dVth at a time t1 when the control period TSX2 is started. That is, in the present embodiment, in the discharge section inspection process in the normal inspection mode MD-X, when the discharge section D[m] designated as the inspection target discharge section DK has the predetermined electric storage capacity, it is assumed that the waveform PA-X is set such that the detection potential signal VX[m] does not become equal to or more than the threshold potential Vth from the time t1 when the control period TSX2 is started to the time t2 when the control period TSX2 ends.

FIG. 14 is a diagram illustrating a change in potential of the upper electrode Zu[m] when the discharge section inspection process in the normal inspection mode MD-X is executed. In FIG. 14, it is assumed that the discharge section D[m] designated as the inspection target discharge section DK does not have a predetermined electric storage capacity.

As described above, in the discharge section inspection process, when the discharge section D[m] designated as the inspection target discharge section DK does not have the predetermined electric storage capacity, the potential of the upper electrode Zu[m] in the control period TSX2 changes to approach the drive potential VH from the reference potential V0. Therefore, in the discharge section inspection process in the normal inspection mode MD-X, when the discharge section D[m] designated as the inspection target discharge section DK does not have the predetermined electric storage capacity, the potential of the detection potential signal VX[m] vibrates with the amplitude dVx smaller than the threshold value dVth in the control period TSX2, and the amplitude center changes to approach the drive potential VH from the reference potential V0, as illustrated in FIG. 14. In the present embodiment, in the discharge section inspection process in the normal inspection mode MD-X, when the discharge section D[m] designated as the inspection target discharge section DK does not have the predetermined electric storage capacity, it is assumed that the drive potential VH included in the waveform PA-X is set such that the detection potential signal VX[m] is equal to or more than the threshold potential Vth from the time t1 when the control period TSX2 is started to the time t2 when the control period TSX2 ends. Therefore, in the present embodiment, in the normal inspection mode MD-X, the inspection unit 5 can inspect the state of the discharge section D[m] by inspecting whether the potential of the detection potential signal VX[m] in the control period TSX2 is equal to or more than the threshold potential Vth.

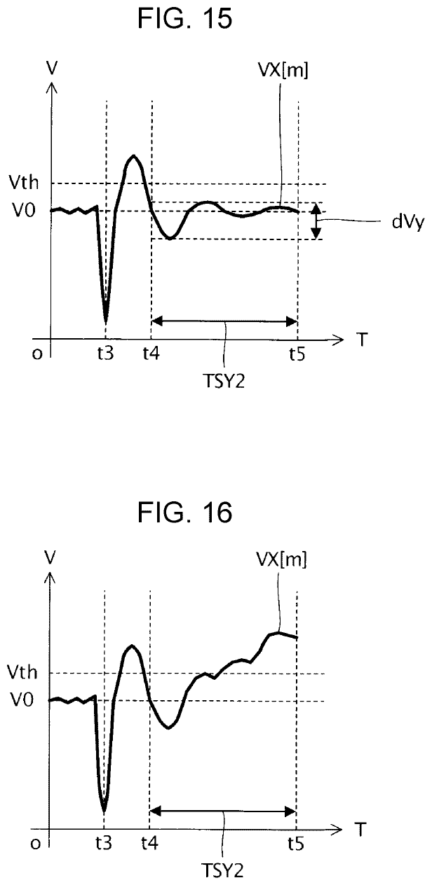

FIG. 15 is a view illustrating a change in potential of the upper electrode Zu[m] when the discharge section inspection process in the high-speed inspection mode MD-Y is executed. In FIG. 15, it is assumed that the discharge section D[m] designated as the inspection target discharge section DK has a predetermined electric storage capacity.

As described above, the inspection drive signal Com-AY changes in potential from the reference potential V0 to the drive potential VH in the control period TY2, and maintains the drive potential VH in the control period TY3. The control period TY2 is shorter than the control period TX2. That is, the inclination of the waveform PA-Y included in the inspection drive signal Com-AY in the control period TY2 is steeper than the inclination of the waveform PA-X included in the inspection drive signal Com-AX in the control period TX2. Therefore, the amplitude of the vibration generated in the drive target discharge section DD at the time t3 when the control period TY2 ends in a case where the discharge section inspection process is executed in the high-speed inspection mode MD-Y is larger than the amplitude of the vibration generated in the drive target discharge section DD at the time t0 when the control period TX2 ends in a case where the discharge section inspection process is executed in the normal inspection mode MD-X.

Meanwhile, as described above, when the discharge section inspection process in the high-speed inspection mode MD-Y is executed, the cavity CV of the discharge section D[m] is not filled with ink (or is filled with a specific type of liquid having a lower viscosity than ink). Therefore, when the discharge section inspection process in the high-speed inspection mode MD-Y is executed, the attenuation of the vibration when the vibration is propagated from the drive target discharge section DD to the discharge section D[m] designated as the inspection target discharge section DK is increased as compared with the case of the normal inspection mode MD-X. Further, when the discharge section inspection process in the high-speed inspection mode MD-Y is executed, the vibration propagated to the inspection target discharge section DK is rapidly attenuated as compared with the case of the normal inspection mode MD-X. Therefore, in the present embodiment, the amplitude dVy of the detection potential signal VX[m] in the control period TSY2 when the discharge section inspection process is executed in the high-speed inspection mode MD-Y is smaller than the amplitude dVx in the control period TSX2 of the detection potential signal VX[m] when the discharge section inspection process is executed in the normal inspection mode MD-X. That is, in the present embodiment, the amplitude dVy of the detection potential signal VX[m] in the control period TSY2 when the discharge section inspection process is executed in the high-speed inspection mode MD-Y is less than the threshold value dVth. That is, in the present embodiment, when the discharge section inspection process is executed in the high-speed inspection mode MD-Y, in a case where the discharge section D[m] designated as the inspection target discharge section DK has a predetermined electric storage capacity, the detection potential signal VX[m] does not become equal to or more than the threshold potential Vth from the time t4 when the control period TSY2 is started to the time t5 when the control period TSY2 ends.

FIG. 16 is a view illustrating a change in potential of the upper electrode Zu[m] when the discharge section inspection process in the high-speed inspection mode MD-Y is executed. In FIG. 16, it is assumed that the discharge section D[m] designated as the inspection target discharge section DK does not have a predetermined electric storage capacity.

As described above, in the discharge section inspection process, when the discharge section D[m] designated as the inspection target discharge section DK does not have the predetermined electric storage capacity, the potential of the upper electrode Zu[m] in the control period TSY2 changes to approach the drive potential VH from the reference potential V0. Therefore, in the discharge section inspection process in the high-speed inspection mode MD-Y, when the discharge section D[m] designated as the inspection target discharge section DK does not have the predetermined electric storage capacity, the potential of the detection potential signal VX[m] vibrates with the amplitude dVy smaller than the threshold value dVth in the control period TSY2, and the amplitude center changes to approach the drive potential VH from the reference potential V0 as illustrated in FIG. 16. In the present embodiment, in the discharge section inspection process in the high-speed inspection mode MD-Y, when the discharge section D[m] designated as the inspection target discharge section DK does not have the predetermined electric storage capacity, it is assumed that the drive potential VH included in the waveform PA-Y is set such that the detection potential signal VX[m] is equal to or more than the threshold potential Vth from the time t4 when the control period TSY2 is started to the time t5 when the control period TSY2 ends. Therefore, in the present embodiment, in the high-speed inspection mode MD-Y, the inspection unit 5 can inspect the state of the discharge section D[m] by inspecting whether the potential of the detection potential signal VX[m] in the control period TSY2 is equal to or more than the threshold potential Vth.

In the present embodiment, it is assumed that both the potential set for the inspection drive signal Com-AX in the control period TSX2 and the potential set for the inspection drive signal Com-AY in the control period TSY2 are the drive potential VH. However, the present disclosure is not limited to such an aspect. The potential at which the inspection drive signal Com-AX is set in the control period TSX2 and the potential at which the inspection drive signal Com-AY is set in the control period TSY2 may be different potentials. In this case, the potential at which the inspection drive signal Com-AX is set in the control period TSX2 may be a potential at which the detection potential signal VX[m] is equal to or more than the threshold potential Vth in the control period TSX2 when the discharge section D[m] designated as the inspection target discharge section DK does not have a predetermined electric storage capacity in the discharge section inspection process in the normal inspection mode MD-X. In addition, the potential at which the inspection drive signal Com-AY is set in the control period TSY2 may be a potential at which the detection potential signal VX[m] is equal to or more than the threshold potential Vth in the control period TSY2 when the discharge section D[m] designated as the inspection target discharge section DK does not have a predetermined electric storage capacity in the discharge section inspection process in the high-speed inspection mode MD-Y.

Hereinafter, in order to clarify the advantages of the discharge section inspection process according to the present embodiment, a discharge section inspection process according to a comparative example will be described.

In the discharge section inspection process according to the comparative example, regardless of whether the cavities CV of the inspection target discharge section DK and the drive target discharge section DD are filled with ink, the unit inspection period TY is set as the operation period of the ink jet printer as in the high-speed inspection mode MD-Y according to the present embodiment, and the inspection mode MD is a mode in which the inspection drive signal Com-AY is supplied as the drive signal Com-A to the head unit 3 and the inspection drive signal Com-BY is supplied as the drive signal Com-B.

FIG. 17 is a diagram illustrating a change in potential of the upper electrode Zu[m] when the discharge section inspection process according to the comparative example is executed. In FIG. 17, it is assumed that the discharge section D[m] designated as the inspection target discharge section DK has a predetermined electric storage capacity and the inspection target discharge section DK and the drive target discharge section DD are filled with ink.

As described above, the control period TY2 in which the potential of the inspection drive signal Com-AY changes from the reference potential V0 to the drive potential VH is shorter than the control period TX2 in which the potential of the inspection drive signal Com-AX changes from the reference potential V0 to the drive potential VH. Therefore, the amplitude of the vibration generated in the drive target discharge section DD at the time t3 when the control period TY2 ends in a case where the discharge section inspection process according to the comparative example is executed is larger than the amplitude of the vibration generated in the drive target discharge section DD at the time t0 when the control period TX2 ends in a case where the discharge section inspection process in the normal inspection mode MD-X in the present embodiment is executed.

Meanwhile, as described above, the discharge section inspection process according to the comparative example is a process assumed that the cavity CV of the discharge section D[m] is filled with ink. Therefore, when the discharge section inspection process according to the comparative example is executed, the vibration propagated from the drive target discharge section DD to the discharge section D[m] designated as the inspection target discharge section DK is larger than when the discharge section inspection process in the normal inspection mode MD-X in the present embodiment is executed. Furthermore, when the discharge section inspection process according to the comparative example is executed, the rate of attenuation of the vibration in the inspection target discharge section DK is substantially the same as that when the discharge section inspection process in the normal inspection mode MD-X according to the present embodiment is executed. Therefore, the amplitude dVz of the detection potential signal VX[m] in the control period TSY2 when the discharge section inspection process according to the comparative example is executed is larger than the amplitude dVx of the detection potential signal VX[m] in the control period TSX2 when the discharge section inspection process in the normal inspection mode MD-X according to the present embodiment is executed. For example, the amplitude dVz of the detection potential signal VX[m] in the control period TSY2 is equal to or more than the threshold value dVth when the discharge section inspection process according to the comparative example is executed. That is, in the discharge section inspection process according to the comparative example, even when the discharge section D[m] designated as the inspection target discharge section DK has a predetermined electric storage capacity, the detection potential signal VX[m] is equal to or more than the threshold potential Vth in the control period TSY2.

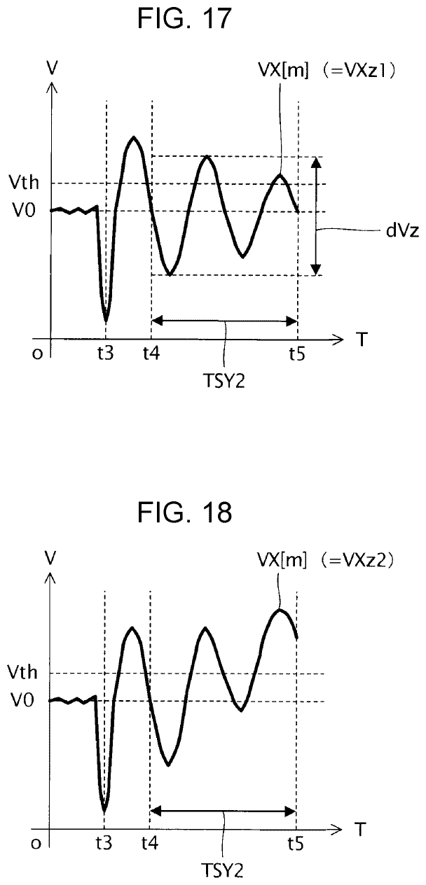

FIG. 18 is a diagram illustrating a change in potential of the upper electrode Zu[m] when the discharge section inspection process according to the comparative example is executed. In FIG. 18, it is assumed that the discharge section D[m] designated as the inspection target discharge section DK does not have a predetermined electric storage capacity, and the inspection target discharge section DK and the drive target discharge section DD are filled with ink.

As described above, in the discharge section inspection process, when the discharge section D[m] designated as the inspection target discharge section DK does not have the predetermined electric storage capacity, the potential of the upper electrode Zu[m] in the control period TSY2 changes to approach the drive potential VH from the reference potential V0. Therefore, in the discharge section inspection process according to the comparative example, when the discharge section D[m] designated as the inspection target discharge section DK does not have the predetermined electric storage capacity, the potential of the detection potential signal VX[m] changes such that the potential vibrates with the amplitude dVz equal to or more than the threshold value dVth in the control period TSY2 as illustrated in FIG. 18 and the amplitude center approaches the drive potential VH from the reference potential V0. Then, in the discharge section inspection process according to the comparative example, when the discharge section D[m] designated as the inspection target discharge section DK does not have the predetermined electric storage capacity, the detection potential signal VX[m] is equal to or more than the threshold potential Vth in the control period TSY2. That is, in the discharge section inspection process according to the comparative example, the detection potential signal VX[m] is equal to or more than the threshold potential Vth in the control period TSY2 regardless of the presence or absence of the predetermined electric storage capacity of the discharge section D[m].

### 4. Summary of Present Embodiment

As described above, in the discharge section inspection process according to the comparative example, in the inspection drive signal Com-AY used to drive the drive target discharge section DD, the time length of the control period TY2 is equal to or less than the time length of the control period TY4. Thus, the amplitude of the detection potential signal VX[m] in the control period TSY2 is equal to or more than the threshold value dVth, and the detection potential signal VX[m] in the control period TSY2 is equal to or more than the threshold potential Vth, regardless of whether the predetermined electric storage capacity is present in the discharge section D[m]. Therefore, in the discharge section inspection process according to the comparative example, it was difficult to inspect the state of the discharge section D[m] based on the detection potential signal VX[m].

Meanwhile, according to the present embodiment, in the discharge section inspection process in the normal inspection mode MD-X, the time length of the control period TX2 is set to be longer than the time length of the control period TX4 in the inspection drive signal Com-AX used to drive the drive target discharge section DD. Therefore, according to the present embodiment, in the discharge section inspection process in the normal inspection mode MD-X, when the discharge section D[m] has the predetermined electric storage capacity, it is possible to prevent the detection potential signal VX[m] in the control period TSX2 from becoming a potential equal to or more than the threshold potential Vth, and only when the discharge section D[m] does not have the predetermined electric storage capacity, the detection potential signal VX[m] in the control period TSX2 can be set to a potential equal to or more than the threshold potential Vth. As a result, according to the present embodiment, it is possible to suppress the possibility that the inspection accuracy of the discharge section inspection process is lowered due to the vibration propagated from the drive target discharge section DD.

Further, according to the present embodiment, in addition to the discharge section inspection process in the normal inspection mode MD-X, the discharge section inspection process in the high-speed inspection mode MD-Y is possible. Therefore, as compared with the aspect in which only the discharge section inspection process in the normal inspection mode MD-X is possible, the execution time of the discharge section inspection process can be shortened when the cavity CV of the discharge section D[m] is not filled with the ink (or when the cavity CV is filled with a specific type of liquid having a lower viscosity than the ink).

### B. MODIFICATION EXAMPLE

Each embodiment above can be variously modified. A specific aspect of the modification will be described below. Two or more aspects selected in any manner from the following examples can be combined with each other as appropriate within a range not inconsistent with each other. In addition, in the modification examples described below, elements having the same effects and functions as those of the embodiment will be given the reference numerals used in the description above, and each detailed description thereof will be omitted as appropriate.

### Modification Example 1

In the above-described embodiment, a case where the drive target discharge section DD is the discharge section D different from the inspection target discharge section DK is described as an example, but the present disclosure is not limited to such an aspect. The drive target discharge section DD may be the same discharge section D as the inspection target discharge section DK.

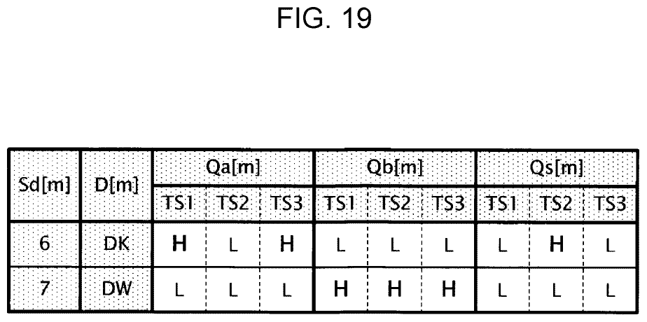

FIG. 19 is an explanatory diagram illustrating an example of an operation of the coupling state designation circuit 310 in the unit inspection period TXY (unit inspection period TX or unit inspection period TY) in the present modification example.

As illustrated in FIG. 19, the individual designation signal Sd[m] according to the present modification example can take any one value of two values, that is, a value “6” for designating the discharge section D[m] as the inspection target discharge section DK and a value “7” for designating the discharge section D[m] as the standby discharge section DW, in the unit inspection period TXY during which the discharge section inspection process is executed.

In the present modification example, it is assumed that the inspection target discharge section DK is a target of driving and an inspection target in the discharge section inspection process. That is, in the present modification example, the inspection target discharge section DK also serves as the drive target discharge section DD according to the embodiment, in addition to serving as the inspection target discharge section DK according to the embodiment.

As illustrated in FIG. 19, in the present modification example, when the individual designation signal Sd[m] indicates the value “6” that designates the discharge section D[m] as the inspection target discharge section DK in the unit inspection period TXY, the coupling state designation circuit 310 maintains the coupling state designation signal Qa[m] at a high level in the control period TS1 and the control period TS3, and maintains the coupling state designation signal Qs[m] at a high level in the control period TS2. In this case, the switch Wa[m] is turned on in the control period TS1 and the control period TS3, and the switch Ws[m] is turned on in the control period TS2. Therefore, the discharge section D[m] is driven by the inspection drive signal Com-AXY (the inspection drive signal Com-AX or the inspection drive signal Com-AY) having the waveform PA-XY (the waveform PA-X or the waveform PA-Y) in the control period TS1, and the potential of the upper electrode Zu[m] of the discharge section D[m] changes from the reference potential V0 to the drive potential VH. Then, the detection circuit 33 detects the potential of the upper electrode Zu[m] included in the discharge section D[m] as the detection potential signal VX[m] via the switch Ws[m] in the control period TS2 (control period TSX2 or control period TSY2).

Further, when the individual designation signal Sd[m] indicates the value “7” that designates the discharge section D[m] as the standby discharge section DW in the unit inspection period TXY, the coupling state designation circuit 310 maintains the coupling state designation signal Qb[m] at a high level throughout the unit inspection period TXY. In this case, the potential of the discharge section D[m] in the control period TS2 (control period TSX2 or control period TSY2) is set to the reference potential V0.

In the present modification example, it is assumed that, in each unit inspection period TXY, one discharge section D[m] among the M discharge sections D[1] to D[M] is designated as the inspection target discharge section DK, and the remaining (M−1) discharge sections D are designated as the standby discharge sections DW.

In the present modification example, when the discharge section D[m] driven as the inspection target discharge section DK has a predetermined electric storage capacity, the potential of the upper electrode Zu[m] in the control period TS2 is maintained at the drive potential VH. Meanwhile, in the present modification example, when the discharge section D[m] driven as the inspection target discharge section DK does not have a predetermined electric storage capacity, that is, when the short-circuit path LK exists between the upper electrode Zu[m] included in the discharge section D[m] designated as the inspection target discharge section DK and the upper electrode Zu included in the discharge section D designated as the standby discharge section DW, the potential of the upper electrode Zu[m] changes to approach the reference potential V0 from the drive potential VH in the control period TS2. Therefore, in the present modification example, the detection circuit 33 can inspect whether the discharge section D[m] has a predetermined electric storage capacity by determining whether the potential change amount of the detection potential signal VX[m] in the control period TS2 is smaller than the threshold potential Vth based on the detection signal SK[m].

### Modification Example 2

In the above-described embodiment and Modification Example 1, when the discharge section inspection process is executed in the normal inspection mode MD-X, a case where the inspection drive signal Com-AX is supplied as the drive signal Com-A to the head unit 3 is described as an example, but the present disclosure is not limited to such an aspect. For example, when the discharge section inspection process is executed in the normal inspection mode MD-X, the head unit 3 may be supplied with a signal having a waveform different from that of the inspection drive signal Com-AX as the drive signal Com-A.

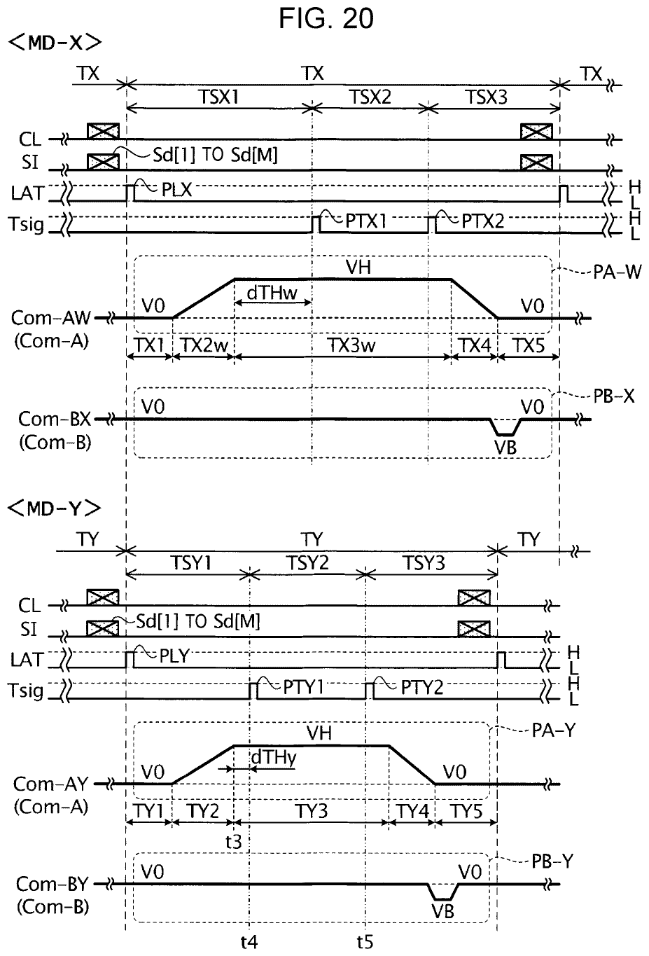

FIG. 20 is a timing chart illustrating an example of various signals such as the drive signal Com supplied to the head unit 3 in the unit inspection period TX and the unit inspection period TY according to the present modification example.

As illustrated in FIG. 20, in the present modification example, the discharge section inspection process is different from the discharge section inspection process according to the embodiment in that, when the discharge section inspection process is executed, an inspection drive signal Com-AW is supplied to the head unit 3 instead of the inspection drive signal Com-AX.

As illustrated in FIG. 20, the inspection drive signal Com-AW has a waveform PA-W provided in the unit inspection period TX. Here, the waveform PA-W is a waveform that maintains the reference potential V0 in the control period TX1 in the unit inspection period TX, changes in potential from the reference potential V0 to the drive potential VH in a control period TX2w following the control period TX1 in the unit inspection period TX, maintains the drive potential VH in a control period TX3w following the control period TX2w in the unit inspection period TX, changes in potential from the drive potential VH to the reference potential V0 in a control period TX4 following the control period TX3w in the unit inspection period TX, and maintains the reference potential V0 in a control period TX5 following the control period TX4 in the unit inspection period TX.

Among these, the control period TX2w is included in the control period TSX1, and starts after the start of the control period TSX1 and ends before the end of the control period TSX1. In addition, in the present modification example, the time length of the control period TX2w is the same as the time length of the control period TY2.

In addition, the control period TX3w includes a part of the control period TSX1, the entire control period TSX2, and a part of the control period TSX3, starts after the start of the control period TSX1 and before the start of the control period TSX2, and ends after the end of the control period TSX2 and before the end of the control period TSX3. That is, in the present modification example, the control period TSX2 is included in the control period TX3w. In addition, in the present modification example, the time length of the control period TX3w is longer than the time length of the control period TY3. Specifically, an interval dTHw from the start of the control period TX3w to the start of the control period TSX2 is longer than an interval dTHv from the start of the control period TY3 to the start of the control period TSY2.

As described above, according to the present modification example, the interval dTHw from when the drive target discharge section DD is driven by the inspection drive signal Com-AW used in the normal inspection mode MD-X until the detection circuit 33 starts detecting the detection potential signal VX[m] from the inspection target discharge section DK is longer than the interval dTHv from when the drive target discharge section DD is driven by the inspection drive signal Com-AY used in the high-speed inspection mode MD-Y until the detection circuit 33 starts detecting the detection potential signal VX[m] from the inspection target discharge section DK. Therefore, according to the present modification example, for example, it is possible to attenuate the amplitude of the vibration of the detection potential signal VX[m] caused by the vibration propagated from the drive target discharge section DD to the inspection target discharge section DK to a greater extent as compared with the discharge section inspection process according to the comparative example. As a result, according to the present modification example, it is possible to suppress the possibility that the inspection accuracy of the discharge section inspection process is lowered due to the vibration propagated from the drive target discharge section DD.

### Modification Example 3

In the above-described embodiment and Modification Examples 1 and 2, a case where the ink jet printer 1 can execute the discharge section inspection process in the two inspection modes MD of the normal inspection mode MD-X and the high-speed inspection mode MD-Y is described as an example, but the present disclosure is not limited to such an aspect. The ink jet printer 1 may be capable of executing the discharge section inspection process in at least the normal inspection mode MD-X.

### Modification Example 4

In the above-described embodiment and Modification Examples 2 and 3, a case where the inspection target discharge section DK and the drive target discharge section DD are the discharge sections D adjacent to each other is described as an example, but the present disclosure is not limited to such an aspect. The inspection target discharge section DK and the drive target discharge section DD may be discharge sections D that are not adjacent to each other.

### Modification Example 5

Although it is assumed that when the ink jet printer 1 includes four head units 3 in the above-described embodiment and Modification Examples 1 to 4, the present disclosure is not limited to such an aspect. The ink jet printer 1 may include one or more head units 3 and three or less head units 3, or may include five or more head units 3.

### Modification Example 6

In the above-described embodiment and Modification Examples 1 to 5, the case where the ink jet printer 1 is a serial printer is described, but the present disclosure is not limited to such an aspect. The ink jet printer 1 may be a so-called line printer in which a plurality of nozzles N are provided in the head unit 3 to extend wider than the width of the recording paper PP.

### C. APPENDIX

The aspects related to the above embodiments and modification examples are listed below. In addition, in order to facilitate understanding of each aspect, the following description will be made with reference to the drawings with corresponding reference symbols, but the present disclosure is not limited to the illustrated aspect.

### C. 1. Appendix 1

Hereinafter, Appendix 1 will be described. In addition, in the following, a variable m1 is a natural number satisfying “1≤m1≤M”, and a variable m2 is a natural number satisfying “1≤m2≤M” and “m1≠m2”.

### Appendix 1-1

The ink jet printer 1 according to Appendix 1-1 includes: the inspection target discharge section DK including the piezoelectric element PZ[m1] that is displaced in response to the drive signal Com and configured to discharge ink in response to the displacement of the piezoelectric element PZ[m1]; the drive target discharge section DD including the piezoelectric element PZ[m2] that is displaced in response to the drive signal Com and configured to discharge ink in response to the displacement of the piezoelectric element PZ[m2]; and the inspection unit 5 that inspects the state of the inspection target discharge section DK based on the detection signal SK[m1] corresponding to the potential of the piezoelectric element PZ[m1] in the control period TSX2 included in the unit inspection period TX when the drive signal Com (more specifically, the inspection drive signal Com-AX) is supplied to the piezoelectric element PZ[m2] in the unit inspection period TX, in which the drive signal Com maintains the reference potential V0 in the control period TX1 in the unit inspection period TX, changes in potential from the reference potential V0 to the drive potential VH in the control period TX2 following the control period TX1 in the unit inspection period TX, maintains the drive potential VH in the control period TX3 following the control period TX2 in the unit inspection period TX, changes in potential from the drive potential VH to the reference potential V0 in the control period TX4 following the control period TX3 in the unit inspection period TX, and maintains the reference potential V0 in the control period TX5 following the control period TX4 in the unit inspection period TX, the control period TX3 includes the control period TSX2, and the control period TX2 is longer than the control period TX4.

In addition, in Appendix 1-1, the piezoelectric element PZ[m1] is an example of a “first piezoelectric element”, the piezoelectric element PZ[m2] is an example of a “second piezoelectric element”, the inspection target discharge section DK is an example of a “first discharge section”, the drive target discharge section DD is an example of a “second discharge section”, the inspection unit 5 is an example of an “inspection section”, the unit inspection period TX is an example of a “unit period”, the control period TSX2 is an example of an “inspection period”, the control period TX1 is an example of a “first period”, the control period TX2 is an example of a “second period”, the control period TX3 is an example of a “third period”, the control period TX4 is an example of a “fourth period”, the control period TX5 is an example of a “fifth period”, the reference potential V0 is an example of a “first potential”, and the drive potential VH is an example of a “second potential”.

According to Appendix 1-1, since the control period TX2 is longer than the control period TX4 and the vibration generated in the drive target discharge section DD can be suppressed at the timing at which the control period TX2 ends, the noise that is superimposed on the detection signal SK[m1] due to the vibration propagated from the drive target discharge section DD to the inspection target discharge section DK can be reduced. Further, according to Appendix 1-1, since the control period TX4 is set to be shorter than the control period TX2, the time length of the unit inspection period TX required for the inspection of the state of the inspection target discharge section DK can be shortened.

### Appendix 1-2

The ink jet printer 1 according to Appendix 1-2 is the ink jet printer 1 according to Appendix 1-1, in which in the unit inspection period TX, the inspection target discharge section DK and the drive target discharge section DD are in a state where the ink fills.

According to Appendix 1-2, the inspection of the state of the inspection target discharge section DK is performed in a state where the inspection target discharge section DK and the drive target discharge section DD are filled with ink. Therefore, it is possible to reduce the labor required for switching between the formation of an image by discharging ink from the ink jet printer 1 and the inspection of the inspection target discharge section DK, as compared with the aspect in which the inspection of the state of the inspection target discharge section DK is performed in a state where the inspection target discharge section DK and the drive target discharge section DD are not filled with ink.

### Appendix 1-3

The ink jet printer 1 according to Appendix 1-3 is the ink jet printer 1 according to Appendix 1-1 or 1-2, in which a flow path provided in the inspection target discharge section DK and a flow path provided in the drive target discharge section DD communicate with the common liquid chamber 327 that stores the ink.

According to Appendix 1-3, the vibration generated in drive target discharge section DD in response to the drive of the drive target discharge section DD by the drive signal Com is propagated to the inspection target discharge section DK via the common liquid chamber 327, but the control period TX2 is longer than the control period TX4 and the vibration generated in the drive target discharge section DD is suppressed. Therefore, it is possible to reduce the noise that is superimposed on the detection signal SK[m1] due to the vibration propagated from the drive target discharge section DD to the inspection target discharge section DK.

### Appendix 1-4

The ink jet printer 1 according to Appendix 1-4 includes: the inspection target discharge section DK including the piezoelectric element PZ[m1] that is displaced in response to the drive signal Com and configured to discharge ink in response to the displacement of the piezoelectric element PZ[m1]; and the inspection unit 5 that inspects a state of the inspection target discharge section DK based on the detection signal SK[m1] corresponding to the potential of the piezoelectric element PZ[m1] in the control period TSX2 included in the control period TSX1 when the drive signal Com (more specifically, the inspection drive signal Com-AX) is supplied to the piezoelectric element PZ[m1] in the control period TSX1 included in the unit inspection period TX, in which the drive signal Com maintains the reference potential V0 in the control period TX1 in the unit inspection period TX, changes in potential from the reference potential V0 to the drive potential VH in the control period TX2 following the control period TX1 in the unit inspection period TX, maintains the drive potential VH in the control period TX3 following the control period TX2 in the unit inspection period TX, changes in potential from the drive potential VH to the reference potential V0 in the control period TX4 following the control period TX3 in the unit inspection period TX, and maintains the reference potential V0 in the control period TX5 following the control period TX4 in the unit inspection period TX, the control period TX3 includes the control period TSX2, the control period TSX1 does not include the control period TSX2 and includes at least the control period TX2, and the control period TX2 is longer than the control period TX4.

In addition, in Appendix 1-4, the control period TSX1 is an example of a “drive period”.

According to Appendix 1-4, since the control period TX2 is longer than the control period TX4 and the vibration generated in the inspection target discharge section DK can be suppressed at the timing at which the control period TX2 ends, the noise that is superimposed on the detection signal SK[m1] due to the vibration generated in the inspection target discharge section DK can be reduced. Further, according to Appendix 1-4, since the control period TX4 is set to be shorter than the control period TX2, the time length of the unit inspection period TX required for the inspection of the state of the inspection target discharge section DK can be shortened.

### Appendix 1-5

The ink jet printer 1 according to Appendix 1-5 is the ink jet printer 1 according to Appendixes 1-1 to 1-4, in which the inspection unit 5 outputs the inspection result signal SS[m] indicating that the state of the inspection target discharge section DK is abnormal when the potential change of the piezoelectric element PZ[m1] is equal to or more than the threshold value dVth in the control period TSX2.

In addition, in Appendix 1-5, the threshold value dVth is an example of a “reference amount”, and the inspection result signal SS[m] is an example of an “inspection result”.

According to Appendix 1-5, it is possible to inspect whether the piezoelectric element PZ[m1] has a predetermined electric storage capacity based on the change in the potential of the piezoelectric element PZ[m1] in the control period TSX2.

### Appendix 1-6

The ink jet printer 1 according to Appendix 1-6 includes: the inspection target discharge section DK including the piezoelectric element PZ[m1] that is displaced in response to the drive signal Com and configured to discharge ink in response to the displacement of the piezoelectric element PZ[m1]; the drive target discharge section DD including the piezoelectric element PZ[m2] that is displaced in response to the drive signal Com and configured to discharge ink in response to the displacement of the piezoelectric element PZ[m2]; and the inspection unit 5 that inspects the state of the inspection target discharge section DK based on the detection signal SK[m1] corresponding to the potential of the piezoelectric element PZ[m1] in the control period TSX2 included in the unit inspection period TX when the drive signal Com (more specifically, the inspection drive signal Com-AX) is supplied to the piezoelectric element PZ[m2] in the unit inspection period TX, in which the drive signal Com changes in potential from the reference potential V0 to the drive potential VH in the control period TX2 in the unit inspection period TX, maintains the drive potential VH in the control period TX3 following the control period TX2 in the unit inspection period TX, and changes in potential from the drive potential VH to the reference potential V0 in the control period TX4 following the control period TX3 in the unit inspection period TX, the control period TX3 includes the control period TSX2, and the control period TX2 is longer than the control period TX4.

In addition, in Appendix 1-6, the control period TX2 is an example of a “first transition period”, the control period TX3 is an example of a “maintenance period”, and the control period TX4 is an example of a “second transition period”.

### C. 2. Appendix 2

Hereinafter, Appendix 2 will be described. In addition, in Appendix 2, the control period TX1 and the control period TY1 may be referred to as a control period TXY1, the control period TX2 and the control period TY2 may be referred to as a control period TXY2, the control period TX3 and the control period TY3 may be referred to as a control period TXY3, the control period TX4 and the control period TY4 may be referred to as a control period TXY4, and the control period TX5 and the control period TY5 may be referred to as a control period TXY5.

### Appendix 2-1

The ink jet printer 1 according to Appendix 2-1 includes: the inspection target discharge section DK including the piezoelectric element PZ[m1] that is displaced in response to the drive signal Com and configured to discharge ink in response to the displacement of the piezoelectric element PZ[m1]; the drive target discharge section DD including the piezoelectric element PZ[m2] that is displaced in response to the drive signal Com and configured to discharge ink in response to the displacement of the piezoelectric element PZ[m2]; and the inspection unit 5 that inspects the state of the inspection target discharge section DK based on the detection signal SK[m1] corresponding to the potential of the piezoelectric element PZ[m1] in the control period TS2 included in the unit inspection period TXY when the drive signal Com (more specifically, the inspection drive signal Com-AXY) is supplied to the piezoelectric element PZ[m2] in the unit inspection period TXY, in which the inspection unit 5 includes the normal inspection mode MD-X in which the state of the inspection target discharge section DK is inspected in the state in which the inspection target discharge section DK and the drive target discharge section DD are filled with ink and the high-speed inspection mode MD-Y in which the state of the inspection target discharge section DK is inspected in the time shorter than that in the normal inspection mode MD-X, and configured to inspect the inspection target discharge section DK in the plurality of inspection modes MD, the drive signal Com maintains the reference potential V0 in the control period TXY1 in the unit inspection period TXY, changes in potential from the reference potential V0 to the drive potential VH in the control period TXY2 following the control period TXY1 in the unit inspection period TXY, maintains the drive potential VH in the control period TXY3 following the control period TXY2 in the unit inspection period TXY, changes in potential from the drive potential VH to the reference potential V0 in the control period TXY4 following the control period TXY3 in the unit inspection period TXY, and maintains the reference potential V0 in the control period TXY5 following the control period TXY4 in the unit inspection period TXY, the control period TXY3 includes the control period TS2, and the time length of the control period TXY2 (that is, the control period TX2) in the normal inspection mode MD-X is longer than the time length of the control period TXY2 (that is, the control period TY2) in the high-speed inspection mode MD-Y.

In addition, in Appendix 2-1, the piezoelectric element PZ[m1] is an example of a “first piezoelectric element”, the piezoelectric element PZ[m2] is an example of a “second piezoelectric element”, the inspection target discharge section DK is an example of a “first discharge section”, the drive target discharge section DD is an example of a “second discharge section”, the inspection unit 5 is an example of an “inspection section”, the normal inspection mode MD-X is an example of a “first inspection mode”, the high-speed inspection mode MD-Y is an example of a “second inspection mode”, the unit inspection period TXY is an example of a “unit period”, the control period TS2 is an example of an “inspection period”, the control period TXY1 is an example of a “first period”, the control period TXY2 is an example of a “second period”, the control period TXY3 is an example of a “third period”, the control period TXY4 is an example of a “fourth period”, the control period TXY5 is an example of a “fifth period”, the reference potential V0 is an example of a “first potential”, and the drive potential VH is an example of a “second potential”.

When the drive target discharge section DD is driven by the drive signal Com, the drive target discharge section DD vibrates. When the drive target discharge section DD is filled with ink, the vibration generated in the drive target discharge section DD remains for a long period of time as compared with a case where the drive target discharge section DD is not filled with ink. In addition, when the drive target discharge section DD is driven by the drive signal Com and the drive target discharge section DD and the inspection target discharge section DK are filled with ink, strong vibration is propagated from the drive target discharge section DD to the inspection target discharge section DK as compared with a case where the drive target discharge section DD and the inspection target discharge section DK are not filled with ink. Therefore, when the drive target discharge section DD and the inspection target discharge section DK are filled with ink, noise is superimposed on the detection signal SK[m1] due to the vibration propagated from the drive target discharge section DD to the inspection target discharge section DK. As a result, in the discharge section inspection process, the inspection accuracy of the inspection target discharge section DK based on the detection signal SK[m1] may have been lowered.

Meanwhile, according to Appendix 2-1, the discharge section inspection process in the normal inspection mode MD-X in which the control period TXY2 is set to be long can be performed in a state where the drive target discharge section DD and the inspection target discharge section DK are filled with ink. Therefore, according to Appendix 2-1, the vibration propagated from the drive target discharge section DD to the inspection target discharge section DK can be reduced as compared with the aspect in which only the discharge section inspection process in the high-speed inspection mode MD-Y can be performed, and the inspection accuracy of the inspection target discharge section DK in the discharge section inspection process can be improved.

Further, according to Appendix 2-1, the discharge section inspection process in the high-speed inspection mode MD-Y, which is capable of performing the inspection in a shorter time than the normal inspection mode MD-X, can be performed. Therefore, when the vibration propagated from the drive target discharge section DD to the inspection target discharge section DK is small, the discharge section inspection process can be executed in a short time.

### Appendix 2-2

The ink jet printer 1 according to Appendix 2-2 is the ink jet printer 1 according to Appendix 2-1, in which the high-speed inspection mode MD-Y is the inspection mode MD for inspecting the state of the inspection target discharge section DK in a state where the inspection target discharge section DK and the drive target discharge section DD are not filled with ink.

According to Appendix 2-2, the discharge section inspection process in the high-speed inspection mode MD-Y in which the control period TXY2 is set to be short is executed in the state where the drive target discharge section DD is not filled with the ink. In a state where the drive target discharge section DD is not filled with the ink, as compared with a state where the drive target discharge section DD is filled with the ink, the vibration generated in the drive target discharge section DD when the drive target discharge section DD is driven by the drive signal Com is eliminated in a short time. Therefore, it is possible to suppress the decrease in the inspection accuracy of the discharge section inspection process due to the vibration propagated from the drive target discharge section DD to the inspection target discharge section DK. Therefore, according to Appendix 2-2, it is possible to achieve both the suppression of the decrease in the inspection accuracy of the discharge section inspection process and the acceleration of the discharge section inspection process.

### Appendix 2-3

The ink jet printer 1 according to Appendix 2-3 is the ink jet printer 1 according to Appendix 2-1, in which the normal inspection mode MD-X is the inspection mode MD for inspecting the state of the inspection target discharge section DK in a state where the inspection target discharge section DK and the drive target discharge section DD are filled with ink, and the high-speed inspection mode MD-Y is the inspection mode MD for inspecting the state of the inspection target discharge section DK in a state where the inspection target discharge section DK and the drive target discharge section DD are filled with a specific type of liquid having a lower viscosity than ink.

In addition, in Appendix 2-3, the ink is an example of a “first type of liquid”, and the specific type of liquid is an example of a “second type of liquid”.

According to Appendix 2-3, the discharge section inspection process is executed in the normal inspection mode MD-X in which the control period TXY2 is set to be long in a state where the drive target discharge section DD is filled with the high viscosity ink, and the discharge section inspection process is executed in the high-speed inspection mode MD-Y in which the control period TXY2 is set to be short in a state where the drive target discharge section DD is filled with the low viscosity specific type of liquid. Therefore, according to Appendix 2-3, when the drive target discharge section DD is filled with the high viscosity ink and the vibration generated in the drive target discharge section DD remains for a long time, the vibration generated in the drive target discharge section DD is suppressed, and the decrease in the inspection accuracy of the discharge section inspection process due to the vibration propagated from the drive target discharge section DD to the inspection target discharge section DK is suppressed. Moreover, when the drive target discharge section DD is filled with the low viscosity specific type of liquid and the vibration generated in the drive target discharge section DD is eliminated in a short time, the acceleration of the discharge section inspection process is prioritized over the suppression of the vibration generated in the drive target discharge section DD. Therefore, according to Appendix 2-3, it is possible to achieve both the suppression of the decrease in the inspection accuracy of the discharge section inspection process and the acceleration of the discharge section inspection process.

### Appendix 2-4

The ink jet printer 1 according to Appendix 2-4 includes: the inspection target discharge section DK including the piezoelectric element PZ[m1] that is displaced in response to the drive signal Com and configured to discharge ink in response to the displacement of the piezoelectric element PZ[m1]; and the inspection unit 5 that inspects the state of the inspection target discharge section DK based on the detection signal SK[m1] corresponding to the potential of the piezoelectric element PZ[m1] in the control period TS2 included in the unit inspection period TXY when the drive signal Com (more specifically, the inspection drive signal Com-AXY) is supplied to the piezoelectric element PZ[m1] in the control period TS1 included in the unit inspection period TXY, in which the inspection unit 5 includes the normal inspection mode MD-X in which the state of the inspection target discharge section DK is inspected in the state in which the inspection target discharge section DK is filled with ink and the high-speed inspection mode MD-Y in which the state of the inspection target discharge section DK is inspected in the time shorter than that in the normal inspection mode MD-X, and configured to inspect the inspection target discharge section DK in the plurality of inspection modes MD, the drive signal Com maintains the reference potential V0 in the control period TXY1 in the unit inspection period TXY, changes in potential from the reference potential V0 to the drive potential VH in the control period TXY2 following the control period TXY1 in the unit inspection period TXY, maintains the drive potential VH in the control period TXY3 following the control period TXY2 in the unit inspection period TXY, changes in potential from the drive potential VH to the reference potential V0 in the control period TXY4 following the control period TXY3 in the unit inspection period TXY, and maintains the reference potential V0 in the control period TXY5 following the control period TXY4 in the unit inspection period TXY, the control period TXY3 includes the control period TS2, the control period TS1 does not include the control period TS2 and includes at least the control period TXY2, and the time length of the control period TXY2 (that is, the control period TX2) in the normal inspection mode MD-X is longer than the time length of the control period TXY2 (that is, the control period TY2) in the high-speed inspection mode MD-Y.

In addition, in Appendix 2-4, the control period TS1 is an example of a “drive period”.

According to Appendix 2-4, the discharge section inspection process in the normal inspection mode MD-X in which the control period TXY2 is set to be long can be performed in a state where the inspection target discharge section DK is filled with ink. Therefore, according to Appendix 2-4, the vibration generated in the inspection target discharge section DK can be reduced as compared with the aspect in which only the discharge section inspection process in the high-speed inspection mode MD-Y is possible, and the inspection accuracy of the inspection target discharge section DK in the discharge section inspection process can be improved.

Further, according to the above-mentioned Appendix 2-4, the discharge section inspection process in the high-speed inspection mode MD-Y, which is capable of performing the inspection in a shorter time than the normal inspection mode MD-X, can be performed. Therefore, when the vibration generated in the inspection target discharge section DK is small, the discharge section inspection process can be executed in a short time.

### Appendix 2-5

The ink jet printer 1 according to Appendixes 2-5 is the ink jet printer 1 according to Appendixes 2-1 to 2-4, in which the inspection unit 5 outputs the inspection result signal SS[m] indicating that the state of the inspection target discharge section DK is abnormal when the potential change of the piezoelectric element PZ[m1] is equal to or more than the threshold value dVth in the control period TS2.

In addition, in Appendix 2-5, the threshold value dVth is an example of a “reference amount”, and the inspection result signal SS[m] is an example of an “inspection result”.

According to Appendix 2-5, it is possible to inspect whether the piezoelectric element PZ[m1] has a predetermined electric storage capacity based on the change in the potential of the piezoelectric element PZ[m1] in the control period TS2.

### Appendix 2-6

The ink jet printer 1 according to Appendix 2-6 includes: the inspection target discharge section DK including the piezoelectric element PZ[m1] that is displaced in response to the drive signal Com and configured to discharge ink in response to the displacement of the piezoelectric element PZ[m1]; the drive target discharge section DD including the piezoelectric element PZ[m2] that is displaced in response to the drive signal Com and configured to discharge ink in response to the displacement of the piezoelectric element PZ[m2]; and the inspection unit 5 that inspects the state of the inspection target discharge section DK based on the detection signal SK[m1] corresponding to the potential of the piezoelectric element PZ[m1] in the control period TS2 included in the unit inspection period TXY when the drive signal Com (more specifically, the inspection drive signal Com-AXY) is supplied to the piezoelectric element PZ[m2] in the unit inspection period TXY, in which the inspection unit 5 includes the normal inspection mode MD-X in which the state of the inspection target discharge section DK is inspected in the state in which the inspection target discharge section DK and the drive target discharge section DD are filled with ink and the high-speed inspection mode MD-Y in which the state of the inspection target discharge section DK is inspected in the time shorter than that in the normal inspection mode MD-X, and configured to inspect the inspection target discharge section DK in the plurality of inspection modes MD, the drive signal Com changes in potential from the reference potential V0 to the drive potential VH in the control period TXY2 in the unit inspection period TXY, maintains the drive potential VH in the control period TXY3 following the control period TXY2 in the unit inspection period TXY, and changes in potential from the drive potential VH to the reference potential V0 in the control period TXY4 following the control period TXY3 in the unit inspection period TXY, the control period TXY3 includes the control period TS2, and the time length of the control period TXY2 (that is, the control period TX2) in the normal inspection mode MD-X is longer than the time length of the control period TXY2 (that is, the control period TY2) in the high-speed inspection mode MD-Y.

In addition, in Appendix 2-6, the control period TXY2 is an example of a “first transition period”, the control period TXY3 is an example of a “maintenance period”, and the control period TXY4 is an example of a “second transition period”.

What is claimed is:

1. A liquid discharge apparatus comprising:
a first discharge section including a first piezoelectric element that is displaced in response to a drive signal and configured to discharge a liquid;
a second discharge section including a second piezoelectric element that is displaced in response to the drive signal and configured to discharge the liquid; and
an inspection section that inspects a state of the first discharge section based on a detection signal corresponding to a potential of the first piezoelectric element in an inspection period included in a unit period when the drive signal is supplied to the second piezoelectric element in the unit period, wherein
the drive signal
maintains a first potential in a first period in the unit period,
changes in potential from the first potential to a second potential in a second period following the first period in the unit period,
maintains the second potential in a third period following the second period in the unit period,
changes in potential from the second potential to the first potential in a fourth period following the third period in the unit period, and
maintains the first potential in a fifth period following the fourth period in the unit period,
the third period includes the inspection period, and
the second period is longer than the fourth period.

2. The liquid discharge apparatus according to claim 1, wherein
in the unit period, the first discharge section and the second discharge section are in a liquid-filled state.

3. The liquid discharge apparatus according to claim 2, wherein
a flow path provided in the first discharge section and a flow path provided in the second discharge section communicate with a common liquid chamber that stores the liquid.

4. A liquid discharge apparatus comprising:
a first discharge section including a first piezoelectric element that is displaced in response to a drive signal and configured to discharge a liquid; and
an inspection section that inspects a state of the first discharge section based on a detection signal corresponding to a potential of the first piezoelectric element in an inspection period included in a unit period when the drive signal is supplied to the first piezoelectric element in a drive period included in the unit period, wherein
the drive signal
maintains a first potential in a first period in the unit period,
changes in potential from the first potential to a second potential in a second period following the first period in the unit period,
maintains the second potential in a third period following the second period in the unit period,
changes in potential from the second potential to the first potential in a fourth period following the third period in the unit period, and
maintains the first potential in a fifth period following the fourth period in the unit period,
the third period includes the inspection period,
the drive period does not include the inspection period and includes at least the second period, and
the second period is longer than the fourth period.

5. A liquid discharge apparatus comprising:
a first discharge section including a first piezoelectric element that is displaced in response to a drive signal and configured to discharge a liquid;
a second discharge section including a second piezoelectric element that is displaced in response to the drive signal and configured to discharge the liquid; and
an inspection section that inspects a state of the first discharge section based on a detection signal corresponding to a potential of the first piezoelectric element in an inspection period included in a unit period when the drive signal is supplied to the second piezoelectric element in the unit period, wherein
the drive signal
changes in potential from a first potential to a second potential in a first transition period in the unit period,
maintains the second potential in a maintenance period following the first transition period in the unit period, and
changes in potential from the second potential to the first potential in a second transition period following the maintenance period in the unit period,
the maintenance period includes the inspection period, and
the first transition period is longer than the second transition period.

6. The liquid discharge apparatus according to claim 1, wherein
the inspection section outputs an inspection result indicating that the state of the first discharge section is abnormal when a change amount in the potential of the first piezoelectric element in the inspection period is equal to or more than a reference amount.

7. A head unit comprising:
a first discharge section including a first piezoelectric element that is displaced in response to a drive signal and configured to discharge a liquid;
a second discharge section including a second piezoelectric element that is displaced in response to the drive signal and configured to discharge the liquid; and
a detection section that detects a potential of the first piezoelectric element in an inspection period included in a unit period when the drive signal is supplied to the second piezoelectric element in the unit period, wherein
the drive signal
maintains a first potential in a first period in the unit period,
changes in potential from the first potential to a second potential in a second period following the first period in the unit period,
maintains the second potential in a third period following the second period in the unit period,
changes in potential from the second potential to the first potential in a fourth period following the third period in the unit period, and
maintains the first potential in a fifth period following the fourth period in the unit period,
the third period includes the inspection period, and
the second period is longer than the fourth period.

8. The head unit according to claim 7, wherein
in the unit period, the first discharge section and the second discharge section are in a liquid-filled state.

9. The head unit according to claim 8, wherein
a flow path provided in the first discharge section and a flow path provided in the second discharge section communicate with a common liquid chamber that stores the liquid.

10. A head unit comprising:
a first discharge section including a first piezoelectric element that is displaced in response to a drive signal and configured to discharge a liquid; and
a detection section that detects a potential of the first piezoelectric element in an inspection period included in a unit period when the drive signal is supplied to the first piezoelectric element in a drive period included in the unit period, wherein
the drive signal
maintains a first potential in a first period in the unit period,
changes in potential from the first potential to a second potential in a second period following the first period in the unit period,
maintains the second potential in a third period following the second period in the unit period,
changes in potential from the second potential to the first potential in a fourth period following the third period in the unit period, and
maintains the first potential in a fifth period following the fourth period in the unit period,
the third period includes the inspection period,
the drive period does not include the inspection period and includes at least the second period, and
the second period is longer than the fourth period.

11. A head unit comprising:
a first discharge section including a first piezoelectric element that is displaced in response to a drive signal and configured to discharge a liquid;
a second discharge section including a second piezoelectric element that is displaced in response to the drive signal and configured to discharge the liquid; and
a detection section that detects a potential of the first piezoelectric element in an inspection period included in a unit period when the drive signal is supplied to the second piezoelectric element in the unit period, wherein
the drive signal
changes in potential from a first potential to a second potential in a first transition period in the unit period,
maintains the second potential in a maintenance period following the first transition period in the unit period, and
changes in potential from the second potential to the first potential in a second transition period following the maintenance period in the unit period,
the maintenance period includes the inspection period, and
the first transition period is longer than the second transition period.

12. The head unit according to claim 7, wherein
the detection section supplies a detection signal corresponding to a detection result of the detection section to an inspection section that inspects a state of the first discharge section based on the detection result of the detection section, and
the inspection section outputs an inspection result indicating that the state of the first discharge section is abnormal when a change amount of the potential of the first piezoelectric element in the inspection period is equal to or more than a reference amount.

13. An inspection method of a liquid discharge apparatus including a first discharge section including a first piezoelectric element that is displaced in response to a drive signal and configured to discharge a liquid, and a second discharge section including a second piezoelectric element that is displaced in response to the drive signal and configured to discharge the liquid, the inspection method comprising:
inspecting a state of the first discharge section based on a detection signal corresponding to a potential of the first piezoelectric element in an inspection period included in a unit period when the drive signal is supplied to the second piezoelectric element in the unit period, wherein
the drive signal
maintains a first potential in a first period in the unit period,
changes in potential from the first potential to a second potential in a second period following the first period in the unit period,
maintains the second potential in a third period following the second period in the unit period,
changes in potential from the second potential to the first potential in a fourth period following the third period in the unit period, and
maintains the first potential in a fifth period following the fourth period in the unit period,
the third period includes the inspection period, and the second period is longer than the fourth period.

14. The inspection method according to claim 13, wherein
in the unit period, the first discharge section and the second discharge section are in a liquid-filled state.

15. The inspection method according to claim 14, wherein
a flow path provided in the first discharge section and a flow path provided in the second discharge section communicate with a common liquid chamber that stores the liquid.

16. An inspection method of a liquid discharge apparatus including a first discharge section including a first piezoelectric element that is displaced in response to a drive signal and configured to discharge a liquid, the inspection method comprising:
inspecting a state of the first discharge section based on a detection signal corresponding to a potential of the first piezoelectric element in an inspection period included in a unit period when the drive signal is supplied to the first discharge section in a drive period included in the unit period, wherein
the drive signal
maintains a first potential in a first period in the unit period,
changes in potential from the first potential to a second potential in a second period following the first period in the unit period,
maintains the second potential in a third period following the second period in the unit period,
changes in potential from the second potential to the first potential in a fourth period following the third period in the unit period, and
maintains the first potential in a fifth period following the fourth period in the unit period,
the third period includes the inspection period,
the drive period does not include the inspection period and includes at least the second period, and
the second period is longer than the fourth period.

17. An inspection method of a liquid discharge apparatus including a first discharge section including a first piezoelectric element that is displaced in response to a drive signal and configured to discharge a liquid, and a second discharge section including a second piezoelectric element that is displaced in response to the drive signal and configured to discharge the liquid, the inspection method comprising:
inspecting a state of the first discharge section based on a detection signal corresponding to a potential of the first piezoelectric element in an inspection period included in a unit period when the drive signal is supplied to the second piezoelectric element in the unit period, wherein
the drive signal
changes in potential from a first potential to a second potential in a first transition period in the unit period,
maintains the second potential in a maintenance period following the first transition period in the unit period, and
changes in potential from the second potential to the first potential in a second transition period following the maintenance period in the unit period,
the maintenance period includes the inspection period, and
the first transition period is longer than the second transition period.

18. The inspection method according to claim 13, further comprising:
outputting an inspection result indicating that the state of the first discharge section is abnormal when a change amount in the potential of the first piezoelectric element in the inspection period is equal to or more than a reference amount.
